(19) United States
(12) Patent Application Publication
(10) Pub. No.: US 2024/0351680 A1
(43) Pub. Date: Oct. 24, 2024

(54) SYSTEMS AND METHODS FOR CONTROLLING WEIGHT DISTRIBUTION OF A REMOTELY PILOTED AIRCRAFT

(71) Applicant: Drone Delivery Canada Corp., Vaughan (CA)

(72) Inventors: Thomas Alan Ulph, North York (CA); Wenkai Xu, Toronto (CA)

(21) Appl. No.: 18/637,571

(22) Filed: Apr. 17, 2024

Related U.S. Application Data
(60) Provisional application No. 63/460,445, filed on Apr. 19, 2023.

(51) Int. Cl. B64C 17/02; B64D 45/00; B64U 10/17; G05D 1/495; G05D 109/25

(52) U.S. Cl. CPC B64C 17/02; B64D 45/00; G05D 1/495; B64U 10/17; B64U 2201/20; G05D 2109/25

(57) ABSTRACT

A system for controlling weight distribution of a remotely piloted aircraft is described. The system comprises a payload weighing platform, a control unit, and a counterweight gantry system. The payload weighing platform is configured to be positioned within the aircraft and receive the payload. The control unit is configured to: receive payload sensor data from the payload weighing platform; determine payload weight and payload center of mass; determine a target position for each of at least one counterweight, the target position determined to control a center of gravity of the aircraft by controlling the weight distribution of the aircraft; and provide a counterweight position signal to the counterweight gantry system. The counterweight gantry system is attached to the aircraft and is configured to move each of the at least one counterweight to corresponding target position in response to receiving the counterweight position signal.

### CROSS-REFERENCE TO RELATED APPLICATION

This application claims priority from U.S. Provisional Patent Application No. 63/460,445 filed on Apr. 19, 2023, the entire contents of which is hereby incorporated by reference.

### FIELD

The described embodiments relate to system and methods for controlling weight distribution and more specifically to controlling weight distribution of a remotely piloted aircraft.

### BACKGROUND

The following is not an admission that anything discussed below is part of the prior art or part of the common general knowledge of a person skilled in the art.

In recent years, there has been a significant increase in the usage of remotely piloted aircrafts (RPA). An RPA can be any aircraft that does not carry a human operator on board and is piloted remotely. RPAs may be used in many applications including military applications, agriculture, aerial photography, transportation, policing and surveillance, infrastructure inspections, forest fire monitoring, entertainment, and science, etc.

In transportation applications, RPAs may be used to transport payloads between different locations. In some cases, RPAs may be used to transport payloads between locations that are remote/inaccessible to other modes of transportation. The distance between the transportation locations may depend on the range/endurance of the RPA. The size, weight and type of payloads that can be transported may depend on various properties of the RPA including, for example, size, weight, propulsion system, and aircraft configuration.

### SUMMARY

In accordance with an aspect of the invention, some embodiments provide a system for controlling weight distribution of a remotely piloted aircraft. The system may comprise a payload weighing platform, a control unit, and a counterweight gantry system. The payload weighing platform may be configured to be positioned within the aircraft and receive the payload. The payload weighing platform may comprise a plurality of weight sensors configured to generate payload sensor data indicating measured weight values. The control unit may be configured to: receive the payload sensor data from the payload weighing platform; determine a payload weight and a payload center of mass based on the payload sensor data and a positional configuration of the plurality of weight sensors; determine a target position for each of at least one counterweight based at least on the payload weight and the payload center of mass, the target position determined to control a center of gravity of the aircraft by controlling the weight distribution of the aircraft; and provide a counterweight position signal to the counterweight gantry system. The counterweight position signal may include the target position. The counterweight gantry system may be attached to the aircraft and may comprise the at least one counterweight. The counterweight gantry system may be configured to move each of the at least one counterweight to corresponding target position in response to receiving the counterweight position signal.

In some embodiments, each of the at least one counterweight is mounted on a corresponding guide rail, and the counterweight gantry system further comprises an actuator system configured to move each of the at least one counterweight to the corresponding target position by: moving the counterweight along the corresponding guide rail; or moving the corresponding guide rail along with the mounted counterweight.

In some embodiments, the payload weighing platform comprises four weight sensors arranged in a rectangular configuration around four corners of the payload weighing platform.

In some other embodiments, the payload weighing platform comprises three weight sensors arranged in a triangular configuration around a center of the payload weighing platform.

In some embodiments, the counterweight gantry system comprises at least two counterweights and further comprises: a first guide rail fixedly attached to the aircraft and generally parallel to a longitudinal axis of the aircraft, wherein a first counterweight of the at least two counterweights is movably mounted on the first guide rail; and a second guide rail fixedly attached to the aircraft and generally parallel to a lateral axis of the aircraft, wherein a second counterweight of the at least two counterweights is movably mounted on the second guide rail, where the actuator system is configured to: move the first counterweight to a first target position by moving the first counterweight along the first guide rail; and move the second counterweight to a second target position by moving the second counterweight along the second guide rail.

In some embodiments, the counterweight gantry system further comprises at least one of the first guide rail being offset from the longitudinal axis by a first offset distance and the second guide rail being offset from the lateral axis by a second offset distance.

In some embodiments, the counterweight gantry system further comprises: a first guide rail fixedly attached to the aircraft and generally parallel to a longitudinal axis of the aircraft; and a second guide rail generally parallel to a lateral axis of the aircraft and movably attached to the first guide rail, wherein the second guide rail is configured to move along the first guide rail, where the at least one counterweight is movably mounted on the second guide rail and the actuator system is configured to move the at least one counterweight to the corresponding target position by moving the at least one counterweight along the second guide rail and by moving the second guide rail along the first guide rail.

In some embodiments, the counterweight gantry system further comprises: a circular guide rail fixedly attached to the aircraft, wherein the circular guide rail circumscribes a majority portion of the aircraft; and a radial guide rail movably attached to the circular guide rail to enable the radial guide rail to move circumferentially around the circular guide rail, where the at least one counterweight is movably mounted on the radial guide rail and the actuator system is configured to move the at least one counterweight to the corresponding target position by moving the at least one counterweight along the radial guide rail and by moving the radial guide rail circumferentially around the circular guide rail.

In some embodiments, the counterweight gantry system comprises the at least one counterweight movably mounted on a longitudinal guide rail fixedly attached to the aircraft and generally parallel to the longitudinal axis of the aircraft; and the actuator system is configured to move the at least one counterweight to the corresponding target position by moving the at least one counterweight along the longitudinal guide rail.

In some embodiments, the counterweight gantry system further comprises: a vertical guide rail fixedly attached to the aircraft and generally parallel to a normal axis of the aircraft; and a vertical counterweight movably mounted on the vertical guide rail, wherein the actuator system is configured to move the vertical counterweight to the corresponding target position by moving the vertical counterweight along the vertical guide rail.

In various embodiments, the counterweight gantry system is attached to an exterior of the aircraft.

In accordance with an aspect of the invention, some embodiments provide a computer-implemented method for controlling weight distribution of a remotely piloted aircraft. The method may comprise: receiving, at a processor, payload sensor data from a payload weighing platform positioned within the aircraft, the payload weighing platform comprising a plurality of weight sensors configured to generate the payload sensor data indicating measured weight values associated with a payload received at the payload weighing platform; determining, at the processor, a payload weight and a payload center of mass of the payload based on the payload sensor data and a positional configuration of the plurality of weight sensors; determining, at the processor, a target position for each of at least one counterweight based at least on the payload weight and the payload center of mass, the target position determined to control a center of gravity of the aircraft by controlling the weight distribution of the aircraft; and providing, by the processor, a counterweight position signal including the target position to a counterweight gantry system attached to the aircraft and comprising the at least one counterweight, the counterweight gantry system configured to move each of the at least one counterweight to corresponding target position in response to receiving the counterweight position signal.

In some embodiments, each of the at least one counterweight is mounted on a corresponding guide rail, and the counterweight gantry system further comprises an actuator system configured to move each of the at least one counterweight to the corresponding target position by: moving the counterweight along the corresponding guide rail; or moving the corresponding guide rail along with the mounted counterweight.

In some embodiments, the payload weighing platform comprises four weight sensors arranged in a rectangular configuration around four corners of the payload weighing platform.

In some other embodiments, the payload weighing platform comprises three weight sensors arranged in a triangular configuration around a center of the payload weighing platform.

In some embodiments, the counterweight gantry system comprises at least two counterweights and further comprises: a first guide rail fixedly attached to the aircraft and generally parallel to a longitudinal axis of the aircraft, wherein a first counterweight of the at least two counterweights is movably mounted on the first guide rail; and a second guide rail fixedly attached to the aircraft and generally parallel to a lateral axis of the aircraft, wherein a second counterweight of the at least two counterweights is movably mounted on the second guide rail, where the actuator system is configured to: move the first counterweight to a first target position by moving the first counterweight along the first guide rail; and move the second counterweight to a second target position by moving the second counterweight along the second guide rail.

In some embodiments, the counterweight gantry system further comprises at least one of the first guide rail being offset from the longitudinal axis by a first offset distance and the second guide rail being offset from the lateral axis by a second offset distance.

In some embodiments, the counterweight gantry system further comprises: a first guide rail fixedly attached to the aircraft and generally parallel to a longitudinal axis of the aircraft; and a second guide rail generally parallel to a lateral axis of the aircraft and movably attached to the first guide rail, wherein the second guide rail is configured to move along the first guide rail, where the at least one counterweight is movably mounted on the second guide rail and the actuator system is configured to move the at least one counterweight to the corresponding target position by moving the at least one counterweight along the second guide rail and by moving the second guide rail along the first guide rail.

In some embodiments, the counterweight gantry system further comprises: a circular guide rail fixedly attached to the aircraft, wherein the circular guide rail circumscribes a majority portion of the aircraft; and a radial guide rail movably attached to the circular guide rail to enable the radial guide rail to move circumferentially around the circular guide rail, where the at least one counterweight is movably mounted on the radial guide rail and the actuator system is configured to move the at least one counterweight to the corresponding target position by moving the at least one counterweight along the radial guide rail and by moving the radial guide rail circumferentially around the circular guide rail.

In some embodiments, the counterweight gantry system comprises the at least one counterweight movably mounted on a longitudinal guide rail fixedly attached to the aircraft and generally parallel to the longitudinal axis of the aircraft; and wherein the actuator system is configured to move the at least one counterweight to the corresponding target position by moving the at least one counterweight along the longitudinal guide rail.

In some embodiments, the counterweight gantry system further comprises: a vertical guide rail fixedly attached to the aircraft and generally parallel to a normal axis of the aircraft; and a vertical counterweight movably mounted on the vertical guide rail, wherein the actuator system is configured to move the vertical counterweight to the corresponding target position by moving the vertical counterweight along the vertical guide rail.

In various embodiments, the counterweight gantry system is attached to an exterior of the aircraft.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram of an example system for controlling weight distribution of an RPA, in accordance with an embodiment.

FIG. 2A is a perspective view of a payload weighing platform of the example system of FIG. 1 positioned within an RPA.

FIG. 2B is a magnified perspective view of the payload weighing platform of FIG. 2A.

FIG. 3A is a schematic diagram showing an example of the weight sensors of the payload weighing platform of FIG. 2A arranged in a symmetric configuration.

FIG. 3B is a schematic diagram showing another example of the weight sensors of the payload weighing platform of FIG. 2A arranged in a symmetric configuration.

FIG. 3C is a schematic diagram showing another example of the weight sensors of the payload weighing platform of FIG. 2A arranged in a symmetric configuration.

FIG. 3D is a schematic diagram showing another example of the weight sensors of the payload weighing platform of FIG. 2A arranged in a symmetric configuration.

FIG. 3E is a schematic diagram showing another example of the weight sensors of the payload weighing platform of FIG. 2A arranged in a symmetric configuration.

FIG. 3F is a schematic diagram showing an example of the weight sensors of the payload weighing platform of FIG. 2A arranged in an asymmetric configuration.

FIG. 4 is a block diagram of a control unit of the example system of FIG. 1.

FIG. 5A is a schematic top view of a counterweight gantry system of the example system of FIG. 1, in accordance with an embodiment.

FIG. 5B is a schematic side view of the counterweight gantry system of FIG. 5A.

FIG. 5C is a schematic top view of a counterweight gantry system of the example system of FIG. 1, in accordance with another embodiment.

FIG. 5D is a schematic side view of the counterweight gantry system of FIG. 5C.

FIG. 6A is a schematic top view of a counterweight gantry system of the example system of FIG. 1, in accordance with another embodiment.

FIG. 6B is a schematic top view of a counterweight gantry system of the example system of FIG. 1, in accordance with another embodiment.

FIG. 7A is a schematic top view of a counterweight gantry system of the example system of FIG. 1, in accordance with another embodiment.

FIG. 7B is a schematic top view of a counterweight gantry system of the example system of FIG. 1, in accordance with another embodiment.

FIG. 8A is a schematic top view of a counterweight gantry system of the example system of FIG. 1, in accordance with another embodiment.

FIG. 8A.

FIG. 8B is a schematic side view of the counterweight gantry system of FIG. 8C is a schematic top view of a counterweight gantry system of the example system of FIG. 1, in accordance with another embodiment.

FIG. 8D is a schematic side view of the counterweight gantry system of FIG. 8C.

FIG. 9A is a schematic top view of a counterweight gantry system of the example system of FIG. 1, in accordance with another embodiment.

FIG. 9B is a schematic top view of a counterweight gantry system of the example system of FIG. 1, in accordance with another embodiment.

FIG. 10 is a perspective view of a counterweight gantry system of the example system of FIG. 1, in accordance with an embodiment.

FIG. 11 is a perspective view of the attachment of the counterweight gantry system of FIG. 10 to structural members of the RPA of FIG. 1, in accordance with an embodiment.

FIG. 12 is a magnified perspective view of a counterweight mounted on a guide rail of the counterweight gantry system of FIG. 10.

FIG. 13 is a flowchart of a method for controlling weight distribution of an RPA, in accordance with an embodiment.

FIG. 14 is a schematic diagram showing the configuration of the weight sensors of the payload weighing platform of the example system of FIG. 1, in accordance with an embodiment.

FIG. 15 is a schematic diagram of position ranges of the center of mass for different payload masses that may be balanced by the example system of FIG. 1, in accordance with an embodiment.

FIG. 16 is a schematic diagram showing a counterweight in addition to the payload weighing platform and weight sensors shown in FIG. 14.

FIG. 17 is a flowchart of a method for controlling weight distribution of an RPA, in accordance with an embodiment.

### DETAILED DESCRIPTION

Several example embodiments are described below. Numerous specific details are set forth in order to provide a thorough understanding of the example embodiments. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formant sense unless expressly so defined herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to “collectively” perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g., 112a, or 1121). Multiple elements herein may be identified by part numbers that share a base number in common and that differ by their suffixes (e.g., 112a, 112b, and 112c). All elements with a common base number may be referred to collectively or generically using the base number without a suffix (e.g., 112).

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Described herein are system and methods for controlling weight distribution of a remotely piloted aircraft (“RPA”). For example, the disclosed systems and method can control the weight distribution of an RPA being used for transporting a payload. Although the disclosed systems and methods are described herein with reference to RPAs, the disclosed systems and methods may be used for controlling weight distribution of any kind of aircrafts, i.e., remotely piloted or manned aircrafts.

An RPA can have a very specific center of gravity (CG) envelope that needs to be maintained during operation. If the specified CG envelope is exceeded, the RPA may experience pitch, roll, and/or yaw instabilities that may reduce controllability and may cause a complete loss of the RPA. For example, the weight and balance of an RPA may be specified as a permissible range of lateral/longitudinal CG locations measured from a specific reference datum. For instance, an RPA may specify a longitudinal CG range of 100 cm to 120 cm from the nose datum and a lateral CG range of 5 cm to 10 cm left of the centerline, at a take-off weight of 500 kg. Additionally, an RPA may specify a range of permissible longitudinal/lateral tilt angles when hung from the rotor hub in take-off configuration. When an example RPA designed around a manned helicopter platform is suspended from the rotor hub, the angle of the RPA may be required to be 2.0° nose down and 2.0° down on the left side, with a +/−1.0° margin of error. Other RPAs may have different specified CG envelopes.

Payloads can be of different sizes, shapes and weights. Loading or unloading a payload from an RPA may change the CG of the RPA depending on the location, weight and weight distribution of the payload. The change in CG of the RPA may shift the CG of the RPA to fall outside the specified CG envelope of the RPA.

For safe and reliable operation of the RPA, the disclosed systems and methods can control the weight distribution of the RPA after any changes to the payload (e.g., loading, unloading, change in position of a loaded payload). The disclosed systems and methods can control the weight distribution of the RPA in various scenarios, such as, for example, a scenario where the RPA is transporting a payload; another scenario where the RPA is not transporting a payload (e.g., the RPA is returning after delivery of a payload at a destination location), etc. The disclosed systems and method may perform the weight distribution control operations before the RPA commences a flight operation. Accordingly, the disclosed systems and method can ensure that the CG of the RPA is within the specified CG envelope for all flight operations.

The disclosed systems may provide an integrated system that can determine payload weight and payload CG, determine any changes that need to be made to the CG of the RPA based on the payload weight and CG, and control the position of one or more counterweights to control the CG of the RPA to be within the specified CG envelope. The CG of an object (e.g., RPA, payload, etc.) may be defined as the average location of the weight of an object. The CG is a hypothetical point around which the resultant torque due to gravity forces vanishes. In other words, the CG of an object is a point about which an object would balance if it were suspended at that point. The disclosed methods may be automatically performed without the requirement of human intervention. Accordingly, the disclosed systems and method can provide an integrated and automated control of the weight distribution of the RPA.

The disclosed systems and methods may provide advantages compared with systems and methods that are not fully integrated/automated. For example, the disclosed systems and methods may provide increased speed/efficiency for payload transportation operations. As another example, the disclosed systems and methods may be used for transporting payloads to/from locations that are remote and do not have any human operators available. The disclosed systems and methods can also control the weight distribution of the RPA to compensate for different sources of errors, such as, for example, human errors in placement of payloads and errors in size or weight measurements of the payload (in cases where the payload is measured before loading onto the RPA). The disclosed systems and methods can address similar sources of errors for manned aircrafts (e.g., manned commercial transport aircrafts).

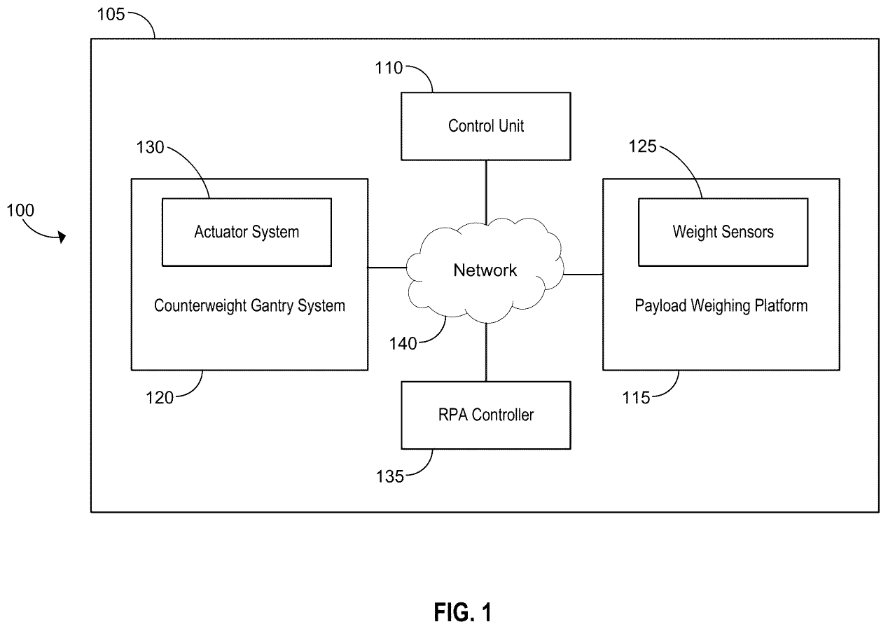

Referring now to FIG. 1, shown therein is a block diagram of a system 100 for controlling weight distribution of an RPA 105. System 100 may include a control unit 110, a payload weighing platform 115, and a counterweight gantry system 120.

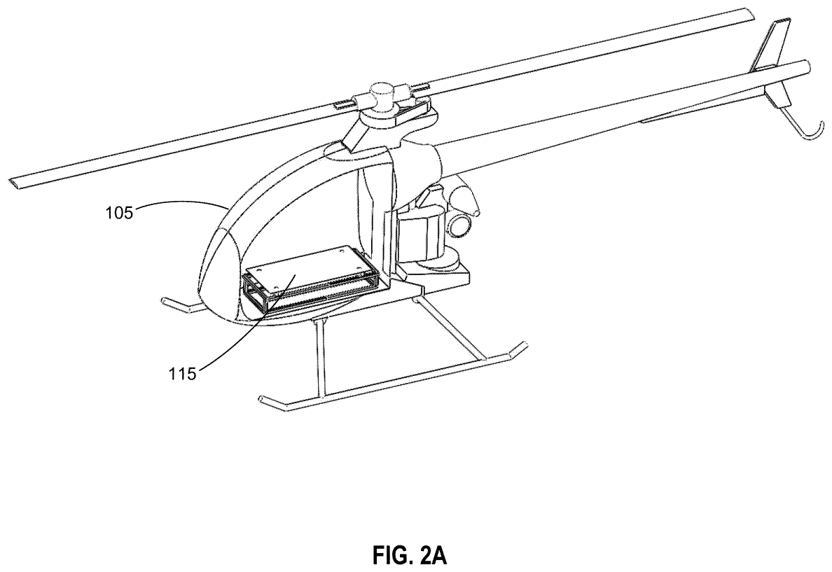

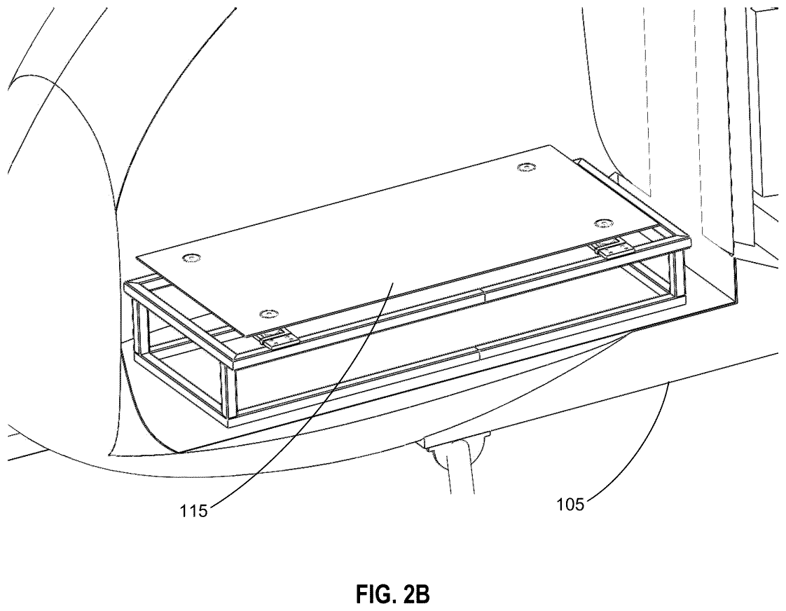

The payload weighing platform 115 may have any suitable design to receive and support a payload carried by RPA 105. In some embodiments, the payload weighing platform 115 may be positioned within RPA 105. Referring now to FIGS. 2A and 2B, shown therein are perspective view of a payload weighing platform 115 positioned within RPA 105.

The payload weighing platform 115 may have multiple weight sensors configured to generate payload sensor data indicating measured weight values. The weight sensors may have any suitable design to provide the payload sensor data. For example, the weight sensors may include load cells that generate a voltage representative of a measured weight value, and the payload sensor data may include the voltage values from the load cells. Each of the multiple weight sensors may generate voltage values that are indicative of a relative portion of the payload mass being supported at that location. A combination of the generated voltage values can provide an indication of a total mass of the payload. Additionally, a center of mass of the payload can be determined based on the generated voltage values and the corresponding locations of the multiple weight sensors of the payload weighing platform 115.

The payload weighing platform 115 may have any suitable number of weight sensors to generate payload sensor data. In various embodiments, the payload weighing platform 115 includes a minimum of two weight sensors. For example, the payload weighing platform 115 may have two to eight weight sensors positioned at different locations on the payload weighing platform 115. In other examples, the payload weighing platform 115 may have a different number of weight sensors (e.g., greater than eight weight sensors).

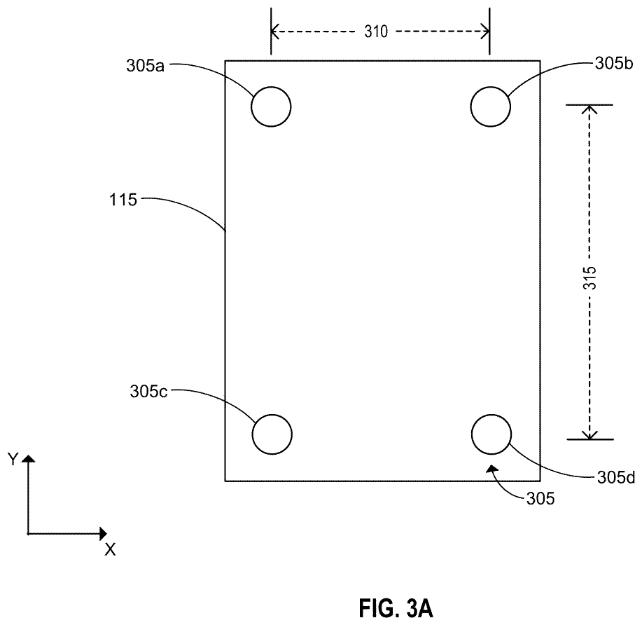

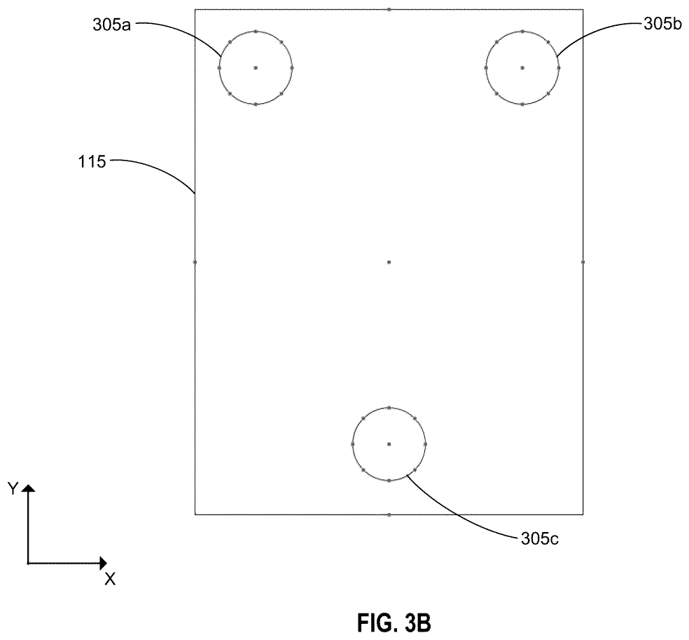

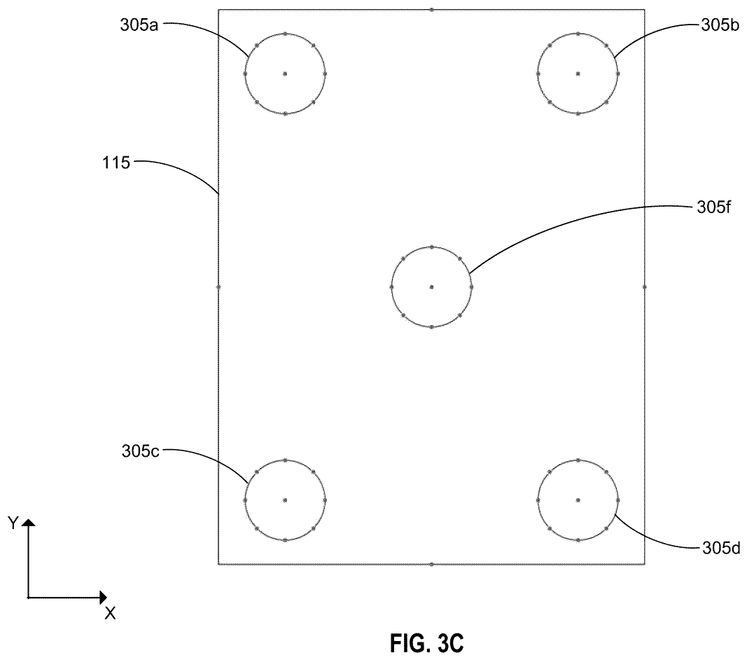

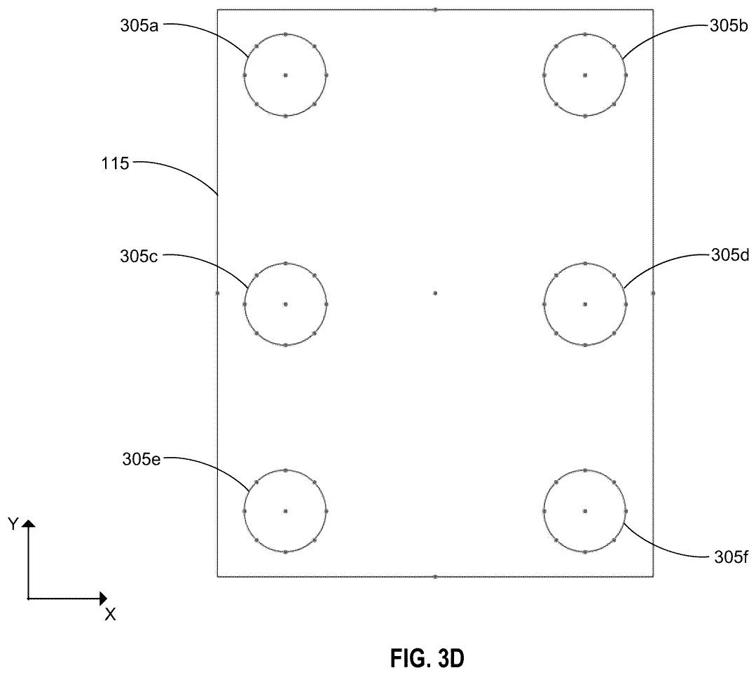

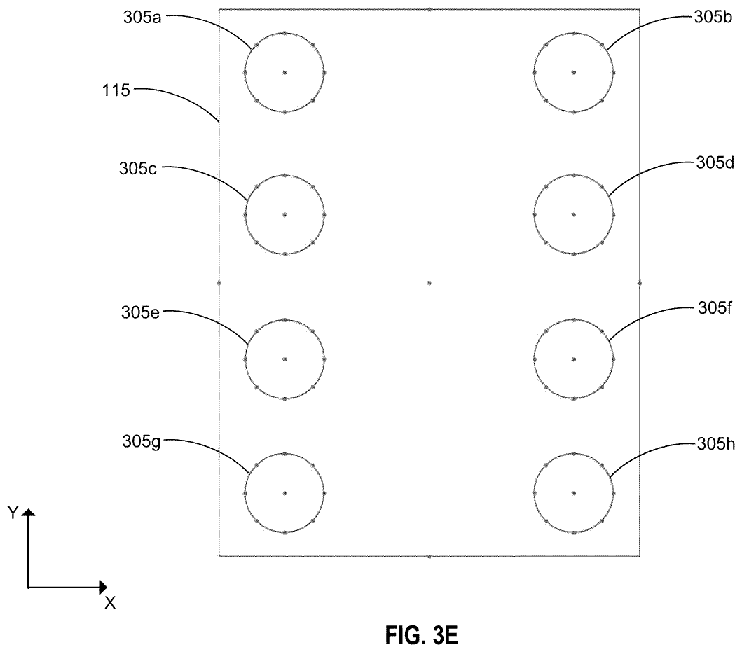

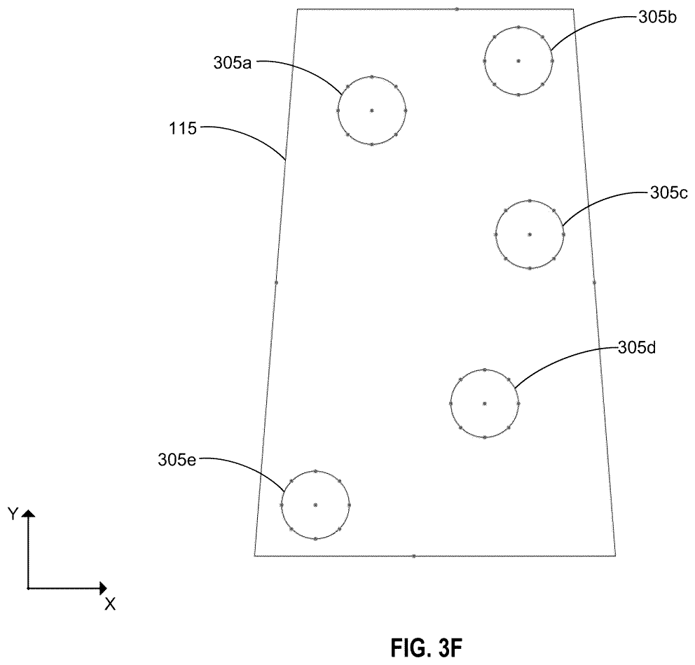

The weight sensors of the payload weighing platform 115 may be arranged in different configurations to generate payload sensor data indicating distribution of mass of the payload. Referring now to FIGS. 3A to 3F, shown therein are examples of different configurations of the weight sensors of the payload weighing platform 115.

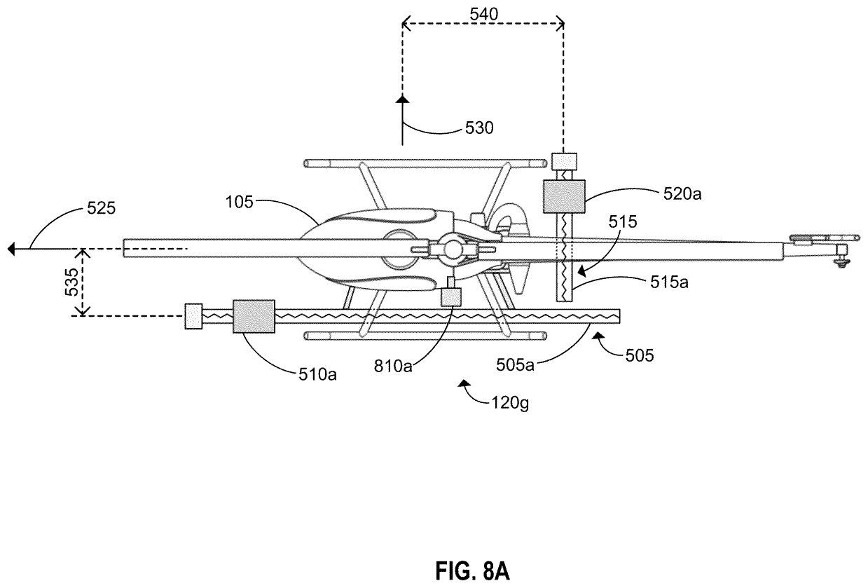

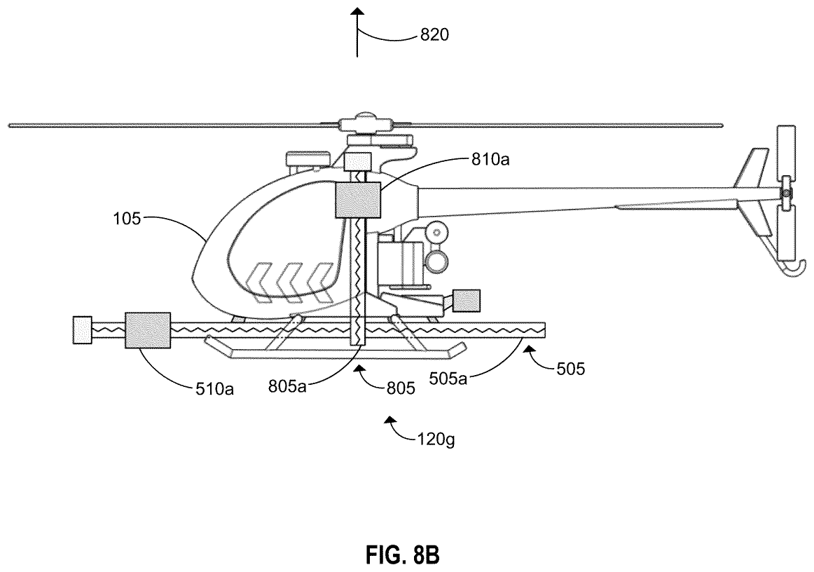

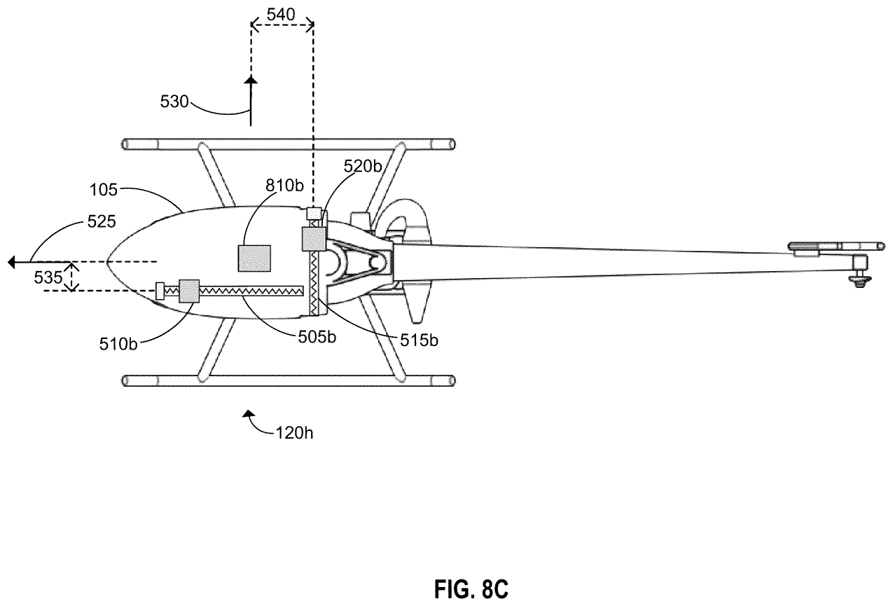

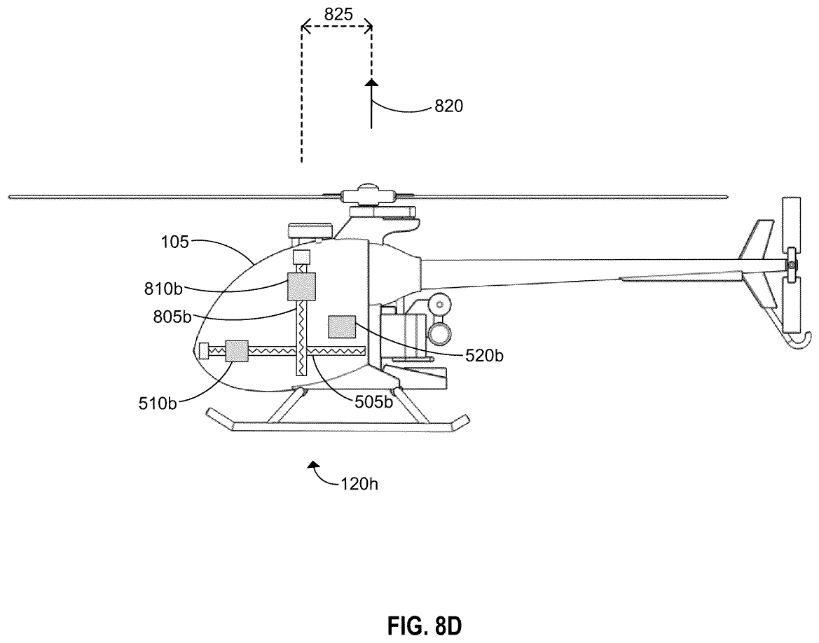

FIG. 3A shows an example configuration having four weight sensors 305a, 305b, 305c, and 305d arranged in a rectangular configuration around four corners of the payload weighing platform 115. The weight sensors may be spaced apart by a distance 310 along an x-axis and by a distance 315 along a y-axis. The payload sensor data generated by weight sensors 305a, 305b, 305c, and 305d can provide an indication of a total mass of the payload and a center of mass (CM) of the payload. The example weight sensors 305a-305d arranged in the x-y plane can provide an indication of a two-dimensional CM of the payload. Additional measurements/sensors may be required to determine the three-dimensional (3D) CM of the payload. For example, additional measurements may be conducted by tilting the payload weighing platform 115 to displace one or more of the weight sensors 305a-305d in a direction normal to the x-y plane. Determination of a 3D CM of the payload may be required in certain circumstances. For example, embodiments of the present disclosure that include a vertical guide rail generally normal to a normal axis of the aircraft may use a 3D CM of the payload to determine a target position for a vertical counterweight mounted on the vertical guide rail (e.g., as described in further detail below with reference to FIG. 8B).

In a similar manner, FIGS. 3B-3E show other example configurations having three, five, six, and eight weight sensors respectively arranged in different symmetric configurations. The payload sensor data generated by weight sensors 305a-305h can provide an indication of a total mass of the payload and a center of mass of the payload.

In some embodiments, the weight sensors may be arranged in asymmetric configurations. For example, FIG. 3F shows an example configuration having five weight sensors 305a-305e arranged in an asymmetric configuration.

The payload carried by RPA 105 may be directly placed on and secured to the payload weighing platform 115. In some embodiments, the payload may be secured to the payload weighing platform 115 using a series of restraints. The restraints may not be connected to other parts of RPA 105 to avoid affecting the payload sensor data generated by the weight sensors 305 of payload weighing platform 115. In some embodiments, the payload may be secured to the RPA (e.g., using restraints) after the payload sensor data is generated to avoid affecting the payload sensor data generated by the weight sensors 305 of payload weighing platform 115.

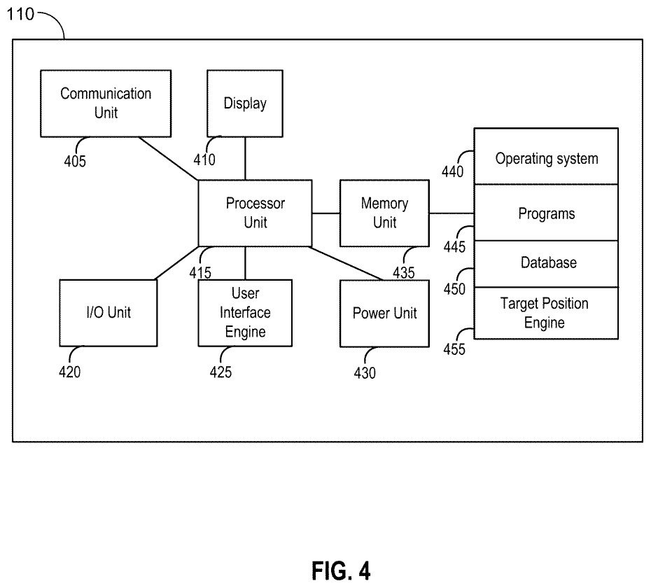

Reference is now made to FIGS. 1 and 4. FIG. 4 shows a block diagram of control unit 110. Control unit 110 may have any design suitable to control operations of system 100. Control unit 110 may be located at RPA 105. In some embodiments, control unit 110 may be located at a remote location and communicate with RPA 105 using a communication network (e.g., network 140). As shown in FIG. 4, control unit 110 may include a communication unit 405, a display 410, a processor unit 415, an I/O unit 420, a user interface engine 425, a power unit 430, and a memory unit 435.

Communication unit 405 can include wired or wireless connection capabilities. Communication unit 405 may be used by control unit 110 to communicate with other devices or computers. For example, control unit 110 may use communication unit 405 to receive payload sensor data from the payload weighing platform 115. The payload sensor data may be provided, for example, by the weight sensors 305 shown in FIG. 3. In some embodiments, control unit 110 may use communication unit 405 to provide a counterweight position signal to the counterweight gantry system 120.

Communication unit 405 may provide control unit 110 with communication to other devices or computers via network 140. Network 140 can be any suitable network that enables control unit 110 to communicate with other devices, systems, and/or users. For example, network 140 may be a communication network such as the Internet, a Wide-Area Network (WAN), a Local-Area Network (LAN), or another type of network. Network 140 may include a point-to-point connection, or another communications connection between two nodes.

In some embodiments, an external device may provide one or more input parameters to control unit 110 using communication unit 405. For example, the input parameters may specify the mass of one or more counterweights of the counterweight gantry system, the specified CG envelope of the RPA, the position of the payload weighing platform within the RPA, and/or the positional configuration of the weight sensors of the payload weighing platform.

Processor unit 415 may control the operation of control unit 110. Processor unit 415 can be any suitable processor, controller or digital signal processor that can provide sufficient processing power depending on the configuration, purposes and requirements of control unit 110 as is known by those skilled in the art. For example, processor unit 415 may include a standard processor, such as a programmable interface (PIC) microcontroller (e.g., an Arduino® microcontroller, Texas Instruments® MSP430 microcontroller or any other suitable microcontroller). Alternatively, processor unit 415 can include more than one processor with each processor being configured to perform different dedicated tasks.

Processor unit 415 can execute a user interface engine 425 that may be used to generate various user interfaces. User interface engine 425 may be configured to provide a user interface on display 410. Optionally, control unit 110 may be in communication with external displays using communication unit 405. User interface engine 425 may also generate user interface data for the external displays that are in communication with control unit 110.

User interface engine 425 can be configured to provide a user interface to an operator of control unit 110. For example, user interface engine 425 can be configured to receive one or more input parameters. For example, the input parameters may specify the mass of one or more counterweights of the counterweight gantry system, the specified CG envelope of the RPA, the position of the payload weighing platform within the RPA, and/or the positional configuration of the weight sensors of the payload weighing platform.

Display 410 may be a LED or LCD based display and may be a touch sensitive user input device that supports gestures. Display 410 may be integrated into control unit 110. Alternatively, display 410 may be located physically remote from control unit 110 and communicate with control unit 110 using, for example, communication unit 405.

I/O unit 420 can include at least one of a mouse, a keyboard, a touch screen, a thumbwheel, a trackpad, a trackball, a card-reader, voice recognition software and the like, depending on the particular implementation of control unit 110. In some cases, some of these components can be integrated with one another. I/O unit 420 may enable an operator of control unit 110 to interact with the user interfaces provided by user interface engine 425.

Power unit 430 can be any suitable power source that provides power to control unit 110 such as a power adaptor or a rechargeable battery pack depending on the implementation of control unit 110 as is known by those skilled in the art.

Memory unit 435 includes software code for implementing an operating system 440, programs 445, database 450, and target position engine 455. Memory unit 435 can include RAM, ROM, one or more hard drives, one or more flash drives or some other suitable data storage elements such as disk drives, etc. Memory unit 435 can be used to store an operating system 440 and programs 445 as is commonly known by those skilled in the art. For instance, operating system 440 provides various basic operational processes for control unit 110. For example, the operating system 440 may be an operating system such as Linux®, Xinu® or Raspberry PI®, or another operating system.

Database 450 may be integrated with control unit 110. Alternatively, database 450 may run independently on a database server in network communication with control unit 110.

Database 450 may store the received input parameters. In some embodiments, database 450 may store the received payload sensor data from the payload weighing platform. Database 450 may also store data corresponding to the target positions for each counterweight of the counterweight gantry system determined to control the weight distribution of the RPA.

Programs 445 can include various programs so that control unit 110 can perform various functions such as, but not limited to, receiving input data, storing received data, and providing a counterweight position signal.

Target position engine 455 can determine a payload weight and a payload center of mass based on received payload sensor data and input parameters like the position of the payload weighing platform within the RPA, and the positional configuration of the weight sensors of the payload weighing platform.

In some embodiments, target position engine 455 can determine a target position for each of at least one counterweight to control a center of gravity of the RPA by controlling the weight distribution of the RPA. Target position engine 455 may determine the target position based on the payload weight and payload center of mass.

Referring back to FIG. 1, the counterweight gantry system 120 may have any suitable design to move each of one or more counterweights to a corresponding target position in response to receiving a counterweight position signal. The counterweight position signal may be provided by control unit 110 and include the target position for each of the counterweights.

The counterweight gantry system 120 may include any suitable number of counterweights, for example, 1 to 3. In some embodiments, the counterweight gantry system 120 may include a larger number of counterweights (e.g., 4 to 6). A smaller number of counterweights (e.g., 1 or 2) may be preferred to reduce the total weight of the counterweight gantry system. Each counterweight may have a precisely known mass. In some embodiments, the mass of each counterweight may be provided as an input parameter to the control unit.

In some embodiments, the counterweight gantry system 120 may include removable counterweights. Different counterweights may be selected and installed in counterweight gantry system 120 based on different factors. Some examples of such factors may include the total payload capacity of the RPA and the payload being transported by the RPA. Smaller counterweights may be selected during one or more flights of the RPA to reduce the total weight of the system and improve the power efficiency of the RPA. Larger counterweights may be selected during one or more flights of the RPA to enable greater control of the weight distribution of the RPA. The specific counterweights selected and installed for a flight may be provided as an input parameter to the control unit.

The counterweight gantry system 120 can include one or more guide rails. In some embodiments, the guide rails may be aligned with reference to the longitudinal and/or the lateral axis of the RPA. In other embodiments, one or more guide rails may not be aligned with the longitudinal and/or the lateral axis of the RPA.

The guide rails may have any design suitable to support a counterweight mounted on the guide rail. The counterweight may be movable along the guide rail. In some embodiments, the guide rail may itself be movable and the movement of the guide rail may result in the corresponding movement of a counterweight mounted on the guide rail. Optionally, multiple counterweights may be mounted on a guide rail. However, this may not provide any additional functionality and may result in an increased weight of the system. Increased weight of the system may have certain disadvantages. For example, increased weight of the system may reduce the payload capacity of the RPA. For example, if an RPA is rated to carry a load of up to 100 kg and if a total weight of the system for controlling the weight distribution of the RPA is 30 kg, then the payload that can be carried by the RPA would be limited to 70 kg. In some cases, increased weight of the system may increase the power consumption of the RPA. This may reduce the flight time of the RPA for the same given payload mass.

The counterweight gantry system 120 can include any suitable number of guide rails. For example, the counterweight gantry system 120 may include 1 to 3 guide rails (with corresponding counterweights mounted on the guide rails) to provide control of weight distribution of the RPA along the corresponding 1 to 3 dimensions. In some embodiments, the counterweight gantry system 120 may include greater than 3 guide rails (e.g., 4 guide rails). However, additional guide rails (beyond 3 guide rails) may not provide any additional functionality but may increase the weight and/or complexity of the system.

In various embodiments, the counterweight gantry system 120 is attached to an exterior of RPA 105. In such embodiments, the RPA 105 may have limited available interior space and positioning the counterweight gantry system 120 on the exterior of RPA 105 may free up the limited interior space for other uses. Additionally, the counterweight gantry system 105 may include longer guide rails compared to the maximum length of guide rails that can fit within the available interior space of the RPA 105. Longer travel distances for counterweights along the guide rails may enable the system to make larger adjustments to the CG of RPA 105. In addition, longer travel distances for counterweights may allow for the use of a smaller counterweight mass while achieving the same CG range.

In various other embodiments, the counterweight gantry system 120 may be fully enclosed within RPA 105. Positioning the counterweight gantry system 120 within RPA 105 may protect the components of the counterweight gantry system 120 from weather and other elements of the external environment. Positioning the counterweight gantry system 120 within interior of RPA 105 may also improve the aerodynamic profile of RPA 105 and reduce impact envelope of RPA 105 with other objects on ground or during flight. The impact envelope of RPA 105 may be defined based on a collision envelope of RPA 105 or an exclusion zone defined around RPA 105 to avoid collision or interference of components of RPA 105 (including the counterweight gantry system) with other objects (e.g., stationary objects like buildings or moving objects like other RPAs, birds etc.).

The counterweight gantry system 120 can include the one or more counterweights where each of the counterweights is mounted on a corresponding guide rail. The counterweight gantry system 120 may also include an actuator system 130 configured to move each of the counterweights to the corresponding target position.

The number of counterweights, the mass of each counterweight, the number of guide rails and/or the geometric configuration of the guide rails may be designed/selected based on different factors including type of RPA (e.g., a single rotor, multi-rotor, fixed-wing RPA), size of RPA (e.g., length, width, payload capacity) and/or range of payloads (e.g., weight, geometric dimensions). The number of counterweights and the mass of each counterweight may also be selected to reduce the total weight of the system. The number of guide rails and the geometric configuration of the guide rails may also be selected to reduce interference with different component of the RPA (e.g., landing gear, cables, sensors etc.)

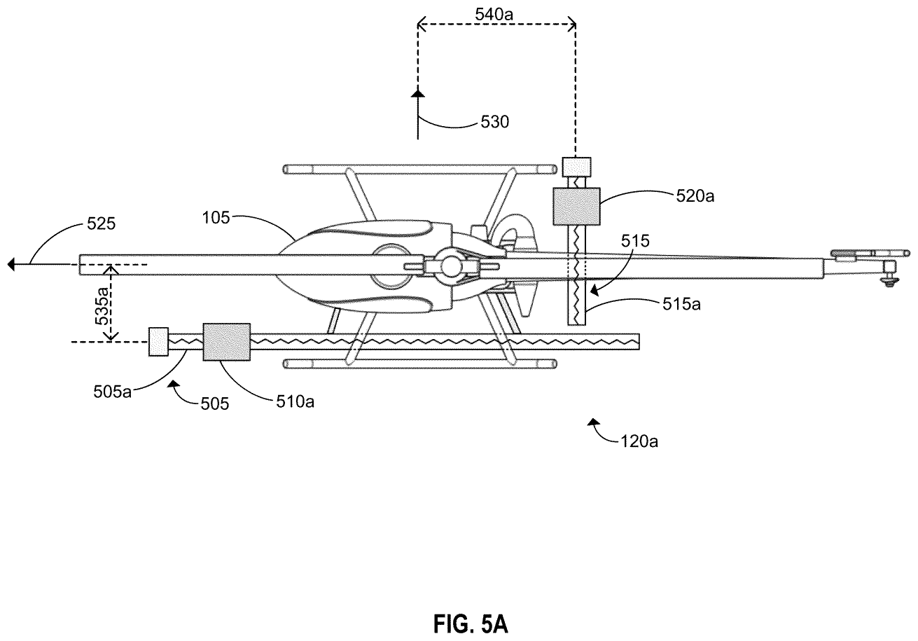

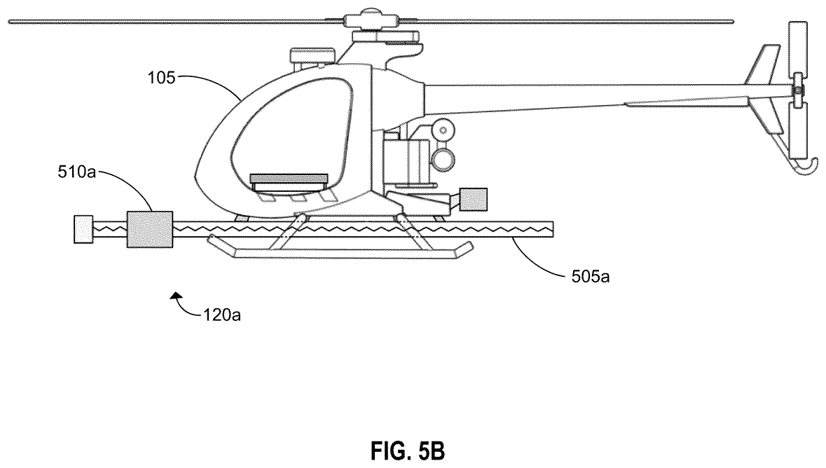

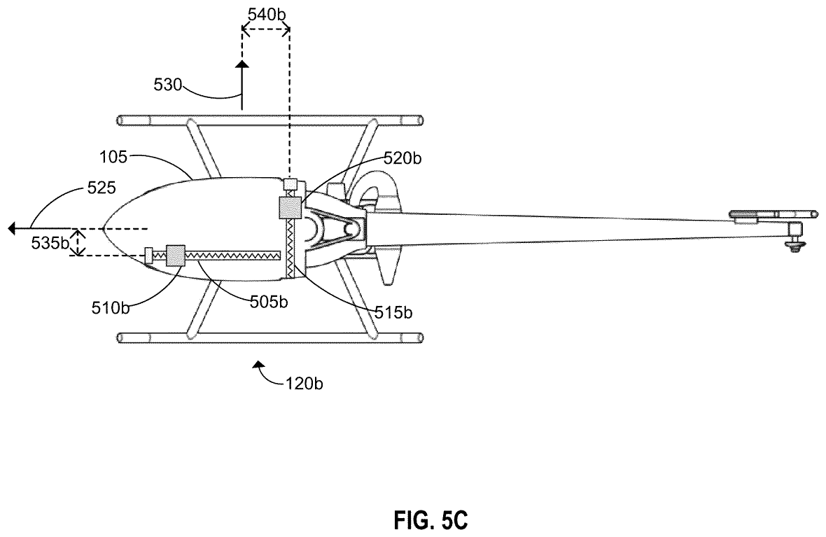

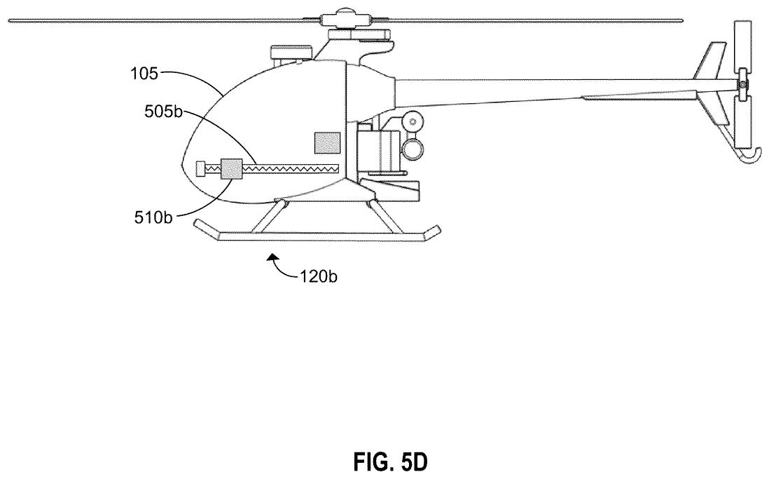

Reference is now made to FIGS. 5A-5D. FIG. 5A shows a schematic top view of a counterweight gantry system 120a attached to the exterior of RPA 105. FIG. 5B shows a schematic side view of the counterweight gantry system 120a attached to the exterior of RPA 105. FIG. 5C shows a schematic top view of a counterweight gantry system 120b positioned within RPA 105. FIG. 5D shows a schematic side view of the counterweight gantry system 120b positioned within RPA 105.

The counterweight gantry system 120a may include a first guide rail 505a, a first counterweight 510a, a second guide rail 515a, and a second counterweight 520a. The first guide rail 505a may be fixedly attached to the exterior of the RPA 105 and may be generally parallel to a longitudinal axis 525 of the RPA 105. The first counterweight 510a may be movably mounted on the first guide rail 505a. The second guide rail 515a may be fixedly attached to the exterior of the RPA 105 and may be generally parallel to a lateral axis 530 of the RPA 105. The second counterweight 520a may be movably mounted on the second guide rail 515.

The counterweight gantry system 120b may include a first guide rail 505b, a first counterweight 510b, a second guide rail 515b, and a second counterweight 520b. The first guide rail 505b may be fixedly attached to the interior of the RPA 105 and may be generally parallel to a longitudinal axis 525 of the RPA 105. The first counterweight 510b may be movably mounted on the first guide rail 505b. The second guide rail 515b may be fixedly attached to the interior of the RPA 105 and may be generally parallel to a lateral axis 530 of the RPA 105. The second counterweight 520b may be movably mounted on the second guide rail 515b.

The counterweight gantry systems 120a and/or 120b may receive a counterweight position signal specifying a first target position for the first counterweight 510 and a second target position for the second counterweight 520. The first target position and the second target position may be determined, for example, by the control system to control a CG of the RPA 105.

The actuator system of the counterweight gantry systems 120a and/or 120b may be configured to move the first counterweight 510 to the first target position by moving the first counterweight 510 along the first guide rail 505. The actuator system may also be configured to move the second counterweight 520 to the second target position by moving the second counterweight 520 along the second guide rail 515.

As shown in FIGS. 5A and 5C, the first guide rail 505 may be offset from the longitudinal axis 525 by a first offset distance 535, and the second guide rail 515 may be offset from the lateral axis 530 by a second offset distance 540. In some embodiments, the RPA operation in flight may require a specified lateral and/or longitudinal angle relative to a specific reference, for example the ground plane or gravitational vector. The offset distances 535 and/or 540 may be selected to assist in achieving the specified lateral and/or longitudinal axes angles. For an example RPA operation, the left side of the RPA may be required to be slightly below the horizontal when the RPA is hung from the rotors. A left side offset of the first guide rail 505 from the longitudinal axis 525 may assist in achieving the specified operation angle. The first offset distance 535 and/or the second offset distance 540 may also be selected to avoid interference of the guide rails with components of the RPA, for example, landing gear, cables etc. In some embodiments, the first guide rail 505 may be aligned along the longitudinal axis 525 and/or the second guide rail 515 may be aligned along the lateral axis 530 (i.e., the first offset distance 535 and/or the second offset distance 540 may be zero).

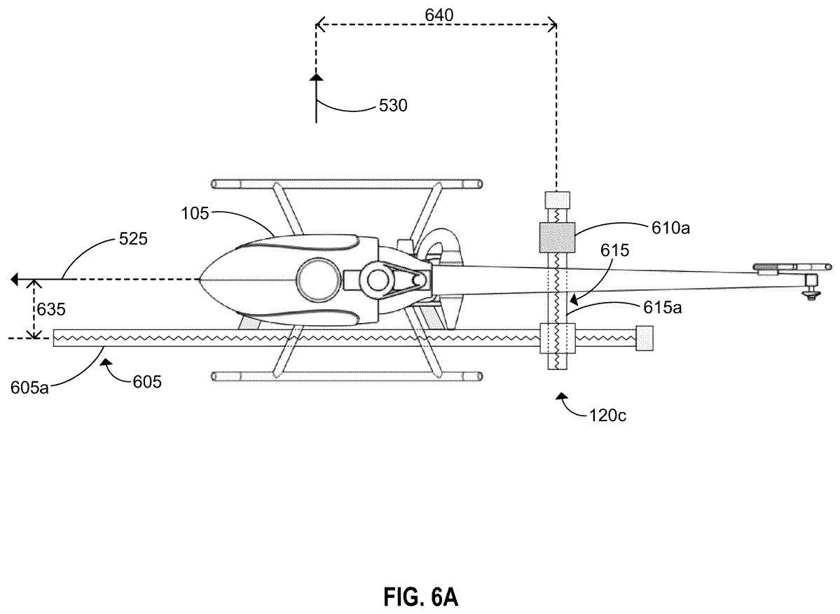

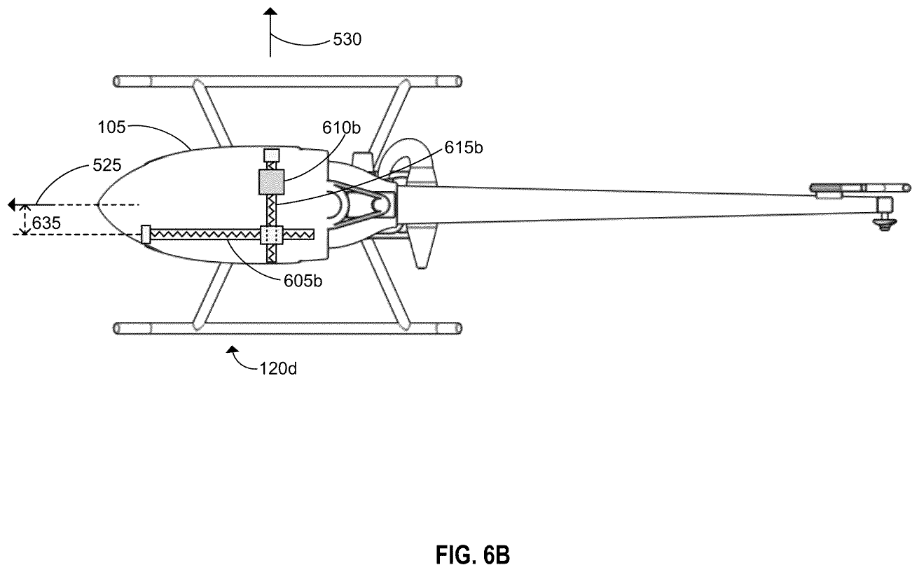

Reference is now made to FIGS. 6A and 6B. FIG. 6A shows a schematic top view of a counterweight gantry system 120c attached to the exterior of RPA 105. FIG. 6B shows a schematic top view of a counterweight gantry system 120d positioned within RPA 105.

The counterweight gantry system 120c may include a first guide rail 605a, a second guide rail 615a, and a counterweight 610a. In the illustrated embodiment, the first guide rail 605a is fixedly attached to the exterior of the RPA 105 and is generally parallel to a longitudinal axis 525 of the RPA 105. The second guide rail 615a is movably attached to the first guide rail 605a. The second guide rail 615a is generally parallel to a lateral axis 530 of the RPA 105. Further, the counterweight 610a is movably mounted on the second guide rail 615a.

The counterweight gantry system 120d may include a first guide rail 605b, a second guide rail 615b, and a counterweight 610b. In the illustrated embodiment, the first guide rail 605b is fixedly attached to the interior of the RPA 105 and is generally parallel to a longitudinal axis 525 of the RPA 105. The second guide rail 615b is movably attached to the first guide rail 605b and is generally parallel to a lateral axis 530 of the RPA 105. The counterweight 610b is movably mounted on the second guide rail 615b.

The counterweight gantry systems 120c and/or 120d may receive a counterweight position signal specifying a target position for the respective counterweight 610. The target position may be determined, for example, by the control system to control a CG of the RPA 105. The actuator system of the counterweight gantry systems 120c and/or 120d may be configured to move the counterweight 610 to the target position by moving the counterweight 610 along the second guide rail 615 and by moving the second guide rail 615 along the first guide rail 605.

As shown in FIGS. 6A and 6B, the first guide rail 605 is offset from the longitudinal axis 525 by a first offset distance 635. In some embodiments, the RPA operation may require a specified lateral angle relative to the ground. The first offset distance 635 may be selected to assist in achieving the specified lateral angles. The first offset distance 635 may also be selected to avoid interference of the guide rails with components of the RPA, for example, landing gear, cables etc.

In some other embodiments, the first guide rail 605 may be aligned along the longitudinal axis 525 (i.e., the first offset distance 635 can be zero).

In the illustrated embodiments of FIGS. 6A and 6B, as the second guide rail 615 moves along the first guide rail 605, an offset distance may result between the second guide rail 615 and the lateral axis 530. This second offset distance 640 is a variable distance, which can be zero when the second guide rail 615 aligns with the lateral axis 530 or non-zero when the second guide rail 615 moves away from the lateral axis 530 as it slides across the first guide rail 605.

As discussed above, FIGS. 6A and 6B illustrate an example embodiment in which the first guide rail 605 is fixedly attached to the RPA and the second guide rail 615 is movably attached to the first guide rail 605. However, in some embodiments, the second guide rail 615 (that is generally parallel to a lateral axis 530 of the RPA 105) may be fixedly attached to the RPA 105. In such embodiments, the first guide rail 605 (that is generally parallel to a longitudinal axis 525 of the RPA 105) may be movably attached to the second guide rails 615. Further, a counterweight may be movably mounted on the first guide rail 605. In such embodiments, the actuator system of the counterweight gantry system may be configured to move a counterweight 610 to the target position by moving the counterweight 610 along the first guide rail 605 and by moving the first guide rail 605 along the second guide rail 615. In such embodiments, the first offset distance 635 can be a variable distance that changes as the first guide rail 605 moves along the second guide rail 615. The second offset distance 615 can be a fixed distance that may be selected to assist in achieving a specified longitudinal angle relative to ground for the RPA operation.

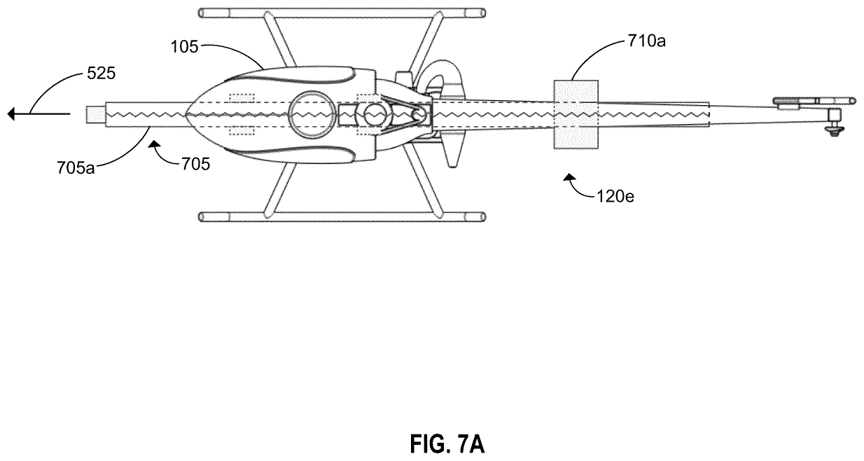

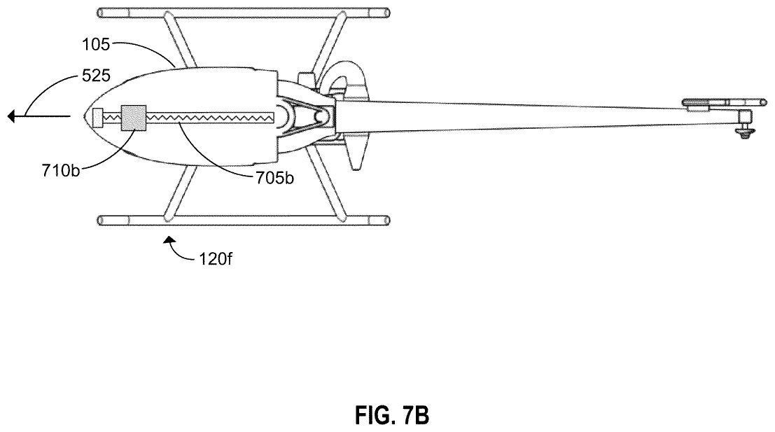

Reference is now made to FIGS. 7A and 7B. FIG. 7A shows a schematic top view of a counterweight gantry system 120e attached to the exterior of RPA 105. FIG. 7B shows a schematic top view of a counterweight gantry system 120f positioned within the interior of RPA 105.

The counterweight gantry system 120e may include a guide rail 705a and a counterweight 710a. The guide rail 705a may be fixedly attached to the exterior of the RPA 105 and may be generally parallel to a longitudinal axis 525 of the RPA 105. The counterweight 710a may be movably mounted on the guide rail 705a.

The counterweight gantry system 120f may include a guide rail 705b and a counterweight 710b. The guide rail 705b may be fixedly attached to the interior of the RPA 105 and may be generally parallel to a longitudinal axis 525 of the RPA 105. The counterweight 710b may be movably mounted on the guide rail 705b.

The counterweight gantry systems 120e and/or 120f may receive a counterweight position signal specifying a target position for the counterweight 710. The target position may be determined, for example, by the control system to control a CG of the RPA 105. The actuator system of the counterweight gantry systems 120e and/or 120f may be configured to move the counterweight 710 to the target position by moving the counterweight 710 along the guide rail 705.

For the illustrated configuration of RPA 105, adding or removing a payload may have a more significant impact on the RPA CG envelope along the longitudinal axis compared with that along a lateral axis. The counterweight gantry systems 120e and/or 120f can enable control of the CG of the RPA 105 along the longitudinal axis but may not be able to control the CG of RPA 105 along a lateral axis. This may impose tighter limits on positioning of the payload in a lateral direction.

As shown in FIGS. 7A and 7B, the guide rail 705 may be aligned along the longitudinal axis 525. In other examples, the guide rail 705 may be offset from the longitudinal axis 525 by an offset distance. In some cases, the RPA operation may require a specified lateral angle relative to the ground. The offset distance may be selected to assist in achieving the specified lateral angle. The offset distance may also be selected to avoid interference of the guide rail 705 with components of the RPA, for example, landing gear, cables etc.

In some embodiments, guide rail 705 may be parallel to a lateral axis (instead of the longitudinal axis) of RPA 105. This may enable the counterweight gantry systems 120e and/or 120f to control of the CG of the RPA 105 along the lateral axis but at the cost of reduced control of the CG along the longitudinal axis.

Reference is now made to FIGS. 8A-8D. FIG. 8A shows a schematic top view of a counterweight gantry system 120g attached to the exterior of RPA 105. FIG. 8B shows a schematic side view of the counterweight gantry system 120g attached to the exterior of RPA 105. FIG. 8C shows a schematic top view of a counterweight gantry system 120h positioned within the interior of RPA 105. FIG. 8D shows a schematic side view of the counterweight gantry system 120h positioned within the interior of RPA 105

The counterweight gantry system 120g may include a first guide rail 505a, a first counterweight 510a, a second guide rail 515a, a second counterweight 520a, a third guide rail 805a, and a third counterweight 810a. The first guide rail 505a may be fixedly attached to the exterior of the RPA 105 and may be generally parallel to a longitudinal axis 525 of the RPA 105. The first counterweight 510a may be movably mounted on the first guide rail 505a. The second guide rail 515a may be fixedly attached to the exterior of the RPA 105 and may be generally parallel to a lateral axis 530 of the RPA 105. The second counterweight 520a may be movably mounted on the second guide rail 515a. The third guide rail 805a may be fixedly attached to the exterior of the RPA 105 and may be generally parallel to a normal axis 820 of the RPA 105. The third counterweight 810a may be movably mounted on the third guide rail 805a.

The counterweight gantry system 120h may include a first guide rail 505b, a first counterweight 510b, a second guide rail 515b, a second counterweight 520b, a third guide rail 805b, and a third counterweight 810b. The first guide rail 505b may be fixedly attached to the interior of the RPA 105 and may be generally parallel to a longitudinal axis 525 of the RPA 105. The first counterweight 510b may be movably mounted on the first guide rail 505b. The second guide rail 515b may be fixedly attached to the interior of the RPA 105 and may be generally parallel to a lateral axis 530 of the RPA 105. The second counterweight 520b may be movably mounted on the second guide rail 515b. The third guide rail 805b may be fixedly attached to the interior of the RPA 105 and may be generally parallel to a normal axis 820 of the RPA 105. The third counterweight 810b may be movably mounted on the third guide rail 805b.

The counterweight gantry systems 120g and/or 120h may receive a counterweight position signal specifying a first target position for the first counterweight 510, a second target position for the second counterweight 520, and a third target position for the third counterweight 810. The first target position, the second target position, and the third target position may be determined, for example, by the control system to control a CG of the RPA 105. The target positions may be determined using additional weight sensors/measurements to determine a three-dimensional CM of the payload. For the example payload weighing platform 115 shown in FIG. 3A, a first set of measurement may be conducted with the payload weighing platform 115 parallel to the x-y plane and a second set of measurements may be conducted by tilting the payload weighing platform 115 with respect to the x-y plane. A three-dimensional CM of the payload can be determined using the first and second set of measurements. The combination of the three counterweights mounted on the three corresponding guide rails may enable the control system to control the CG of the RPA 105 in three dimensions.

The actuator system of the counterweight gantry systems 120g and/or 120h may be configured to move the first counterweight 510 to the first target position by moving the first counterweight 510 along the first guide rail 505. The actuator system may also be configured to move the second counterweight 520 to the second target position by moving the second counterweight 520 along the second guide rail 515. The actuator system may be further configured to move the third counterweight 810 to the third target position by moving the third counterweight 810 along the third guide rail 805.

As shown in FIGS. 8A and 8C, the first guide rail 505 may be offset from the longitudinal axis 525 by a first offset distance 535, and the second guide rail 515 may be offset from the lateral axis 530 by a second offset distance 540. For the example shown in FIG. 8B, the third guide rail 805 may be aligned along the normal axis 820. For the example shown in FIG. 8D, the third guide rail 805 may be offset from the normal axis 820 by a third offset distance 825.

The operation of the RPA may require a specified lateral, longitudinal, and/or normal angle relative to the ground. The corresponding offset distances may be selected to assist in achieving the specified lateral, longitudinal and/or normal angles. The offset distances may also be selected to avoid interference of the guide rails with components of the RPA, for example, landing gear, cables etc.

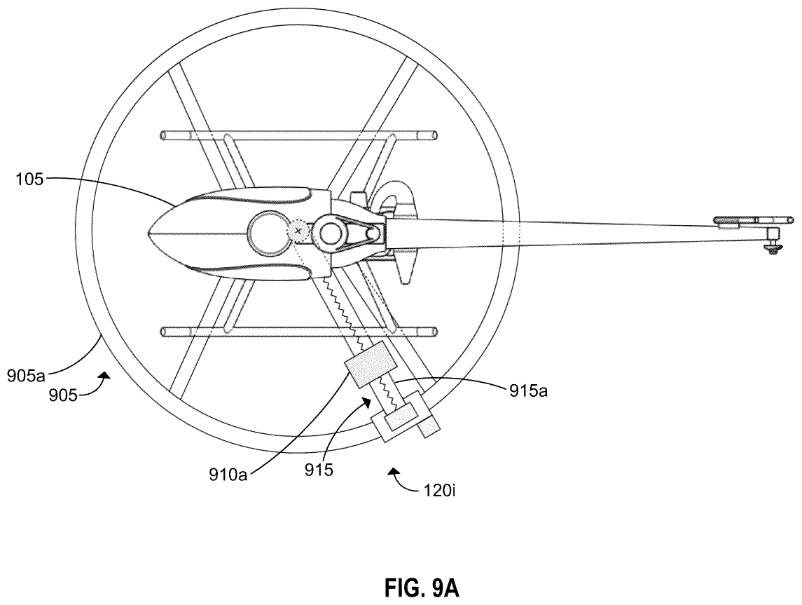

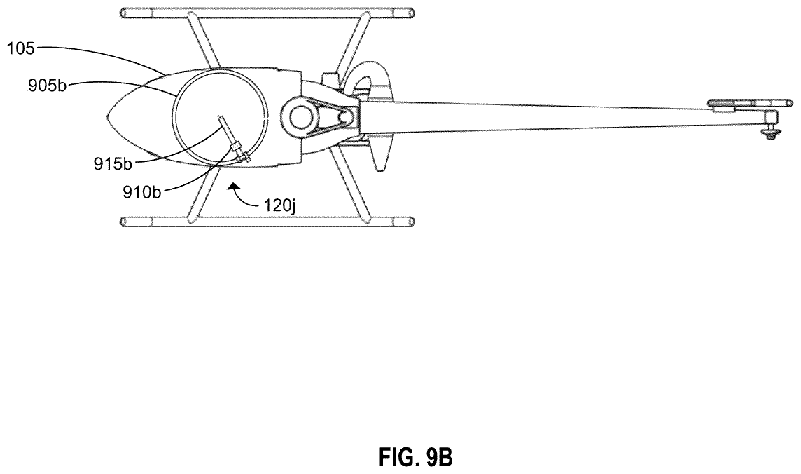

Reference is now made to FIGS. 9A and 9B. FIG. 9A shows a schematic top view of a counterweight gantry system 120i attached to the exterior of RPA 105. FIG. 9B shows a schematic top view of a counterweight gantry system 120j attached to the interior of RPA 105

The counterweight gantry system 120i may include a circular guide rail 905a, a radial guide rail 915a, and a counterweight 910a. The circular guide rail 905a may be fixedly attached to the exterior of the RPA 105. In some embodiments, the circular guide rail 905a may circumscribe a majority portion of the RPA 105. The radial guide rail 915a may be movably attached to the circular guide rail 905a to enable the radial guide rail 915a to move circumferentially around the circular guide rail 905a. The counterweight 910a may be movably mounted on the radial guide rail 915a.

The counterweight gantry system 120j may include a circular guide rail 905b, a radial guide rail 915b, and a counterweight 910b. The circular guide rail 905b may be fixedly attached to the interior of the RPA 105. The radial guide rail 915b may be movably attached to the circular guide rail 905b to enable the radial guide rail 915b to move circumferentially around the circular guide rail 905b. The counterweight 910b may be movably mounted on the radial guide rail 915b.

The counterweight gantry systems 120i and/or 120j may receive a counterweight position signal specifying a target position for the counterweight 910. The target position may be determined, for example, by the control system to control a CG of the RPA 105.

The actuator system of the counterweight gantry systems 120i and/or 120j may be configured to move the counterweight 910 to the target position by moving the counterweight 910 along the radial guide rail 915 and by moving the radial guide rail 915 circumferentially around the circular guide rail 905.

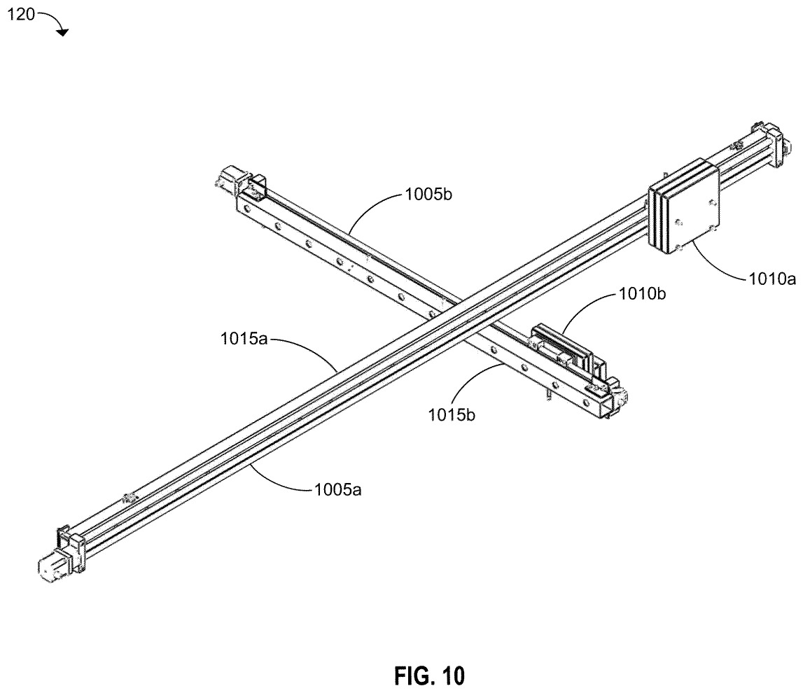

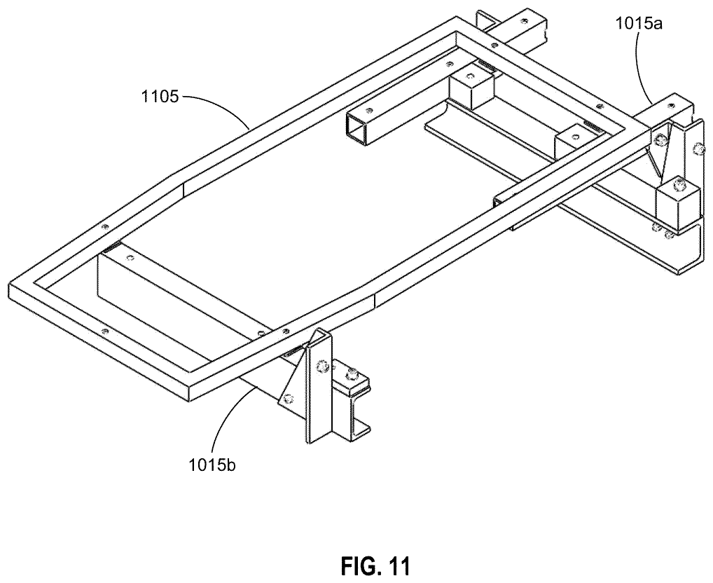

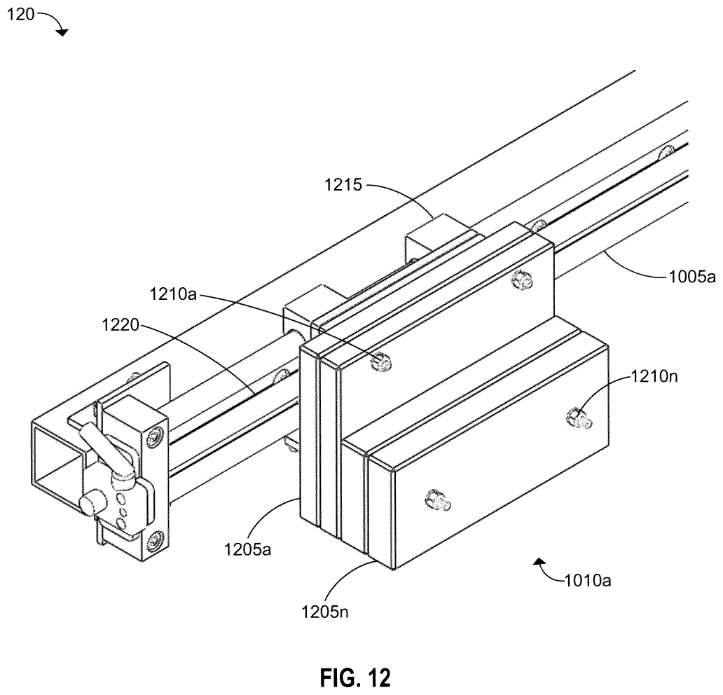

Reference is next made to FIGS. 10 to 12. FIG. 10 shows a perspective view of an example counterweight gantry system 120. FIG. 11 shows a perspective view of the attachment of the counterweight gantry system 120 of FIG. 10 to structural members 1105 of the RPA. FIG. 12 shows a magnified perspective view of a counterweight mounted on a guide rail of the counterweight gantry system 120 of FIG. 10.

As shown in FIG. 10, the counterweight gantry system 120 may include a first guide rail 1005a, a second guide rail 1005b, a first counterweight 1010a, a second counterweight 1010b, a first support member 1015a, and a second support member 1015b.

The guide rails 1005 may have any design suitable to support movement of the counterweights 1010 along the guide rail. Each guide rail 1005 may be fixtured to a corresponding support member 1015. For example, the guide rail 1005a may be bolted to support member 1015a and guide rail 1005b may be bolted to support member 1015b. In another example, the guide rails 1005a, 1005b may be welded to the support members 1015a, 1015b respectively. Alternatively, the guide rails may be bonded, strapped or otherwise fixtured to the respective support members. The guide rails 1005 may be made of any suitable material depending on the mechanical requirements of the counterweight gantry system and the operating environment of the RPA. In some embodiments, the guide rails 1005 may be made using 6061 aluminum alloy materials. In other embodiments, the guide rails 1005 may be made using other materials.

The support members 1015 may have any design suitable to provide structural support for attachment of the counterweight gantry system to the structural members of the RPA. In the illustrated example, the support members 1015 are formed as support beams 1015. In other examples, the support members 1015 may be formed as other structures.

The structural members 1105 may have any design suitable to provide structural support for attachment of the support members. For example, as shown in FIG. 11, the RPA may include square aluminum tubing structural members 1105. The support members 1015a and 1015b may be fixtured to structural members 1105.

In some embodiments, the support members 1015a may be formed as square tubing (as shown in FIG. 11). In other embodiments, the support member 1015a may be formed as other structures. In some embodiments, the support member 1015b may be formed as C-Channel tubing (as shown in FIG. 11). In other embodiments, the support member 1015b may be formed as other structures.

The support members 1015 may be made of any suitable material depending on the mechanical requirements of the counterweight gantry system and the operating environment of the RPA. In some embodiments, the support members 1015 may be made using 6061 aluminum alloy materials. In other embodiments, the support members 1015 may be made using other materials.

The counterweights 1010 may have any suitable design to provide a precisely known mass that can be moved along the guide rails 1005. As shown in FIG. 12, counterweight 1010a may be formed using multiple plates or flat bars 1205a-1205n. Each flat bar 1205 may have a precisely known mass and the total mass of counterweight 1010a may be precisely controlled by controlling the number of flat bars 1205. The multiple flat bars 1205 may be bolted together and attached to a carriage 1215 of the counterweight gantry system using multiple bolts 1210. The flat bars 1205 may be made of any suitable materials, for example, brass or A36 steel alloy.

The carriage 1215 may have any suitable design to enable movement of counterweight 1010a along guide rail 1005a. For example, the counterweight gantry system may include a lead screw 1220 that drives movement of the carriage 1215. In other examples, the counterweight gantry system may include other arrangements, for example, a belt drive system or a rack and pinion system that drives movement of the carriage 1215. The carriage 1215 may include a clamping mechanism to lock the carriage 1215 in position after movement to a target position is completed. The clamping mechanism may be performed by a human operator or may be automated using an actuator.

The lead screw 1220 may be made of any suitable material, for example, 304 stainless steel. The counterweight gantry system may also include a motor to drive the lead screw 1220. In some embodiments, the motor can include a stepper motor. The motor may be controlled based on signals provided by the actuator of the counterweight gantry system.

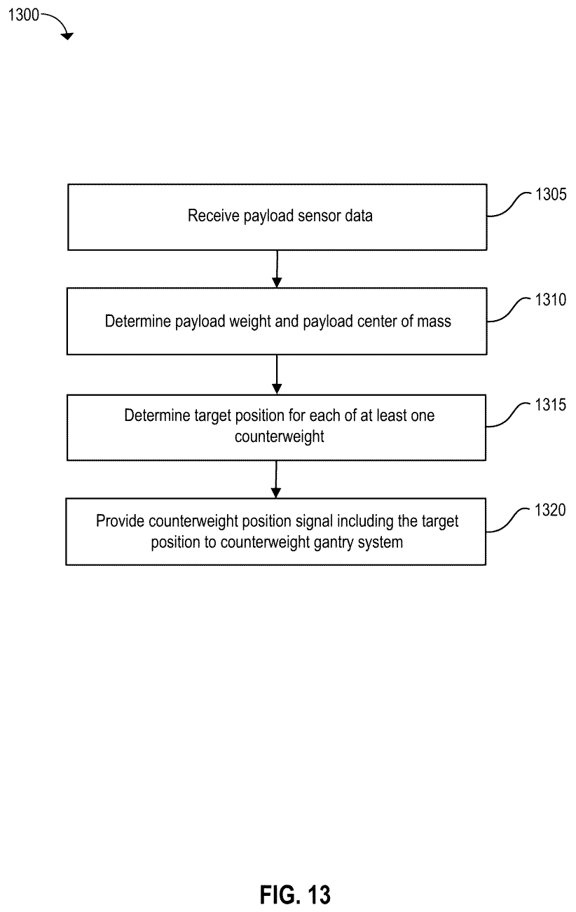

Referring now to FIG. 13, shown therein is a flowchart of an example method 1300 for controlling weight distribution of an RPA, in accordance with an embodiment. Method 1300 can be implemented using, for example, system 100 shown in FIG. 1.

Method 1300 can be performed at various times. For example, method 1300 may be performed after loading a payload on an RPA for transportation from a location A to a location B. After the RPA reaches location B and the payload is unloaded from the RPA, method 1300 may be performed for the next flight operation of the RPA. For example, the next flight operation may be without any payload and method 1300 may be performed after the original payload is unloaded. If a new payload is loaded at location B, method 1300 may be performed after the original payload is unloaded and the new payload is loaded.

Method 1300 may be performed in response to input received from an operator of system 100. For example, an operator may provide an input to control unit 110 to begin method 1300. In some embodiments, method 1300 may not be performed when the RPA is in flight. For example, the method 1300 may only be performed if an aircraft control system of the RPA provides an input to system 100 indicating that the RPA is not in flight.

At 1305, method 1300 may include receiving payload sensor data from a payload weighing platform positioned within the RPA. For example, the payload sensor data may be received by control unit 110 from payload weighing platform 115 positioned within RPA 105. As described herein above with reference to FIGS. 3A-3F, the payload weighing platform 115 may include multiple weight sensors 305 configured to generate payload sensor data indicating payload weight of the payload received at the payload weighing platform 115.

At 1310, method 1300 may include determining payload weight and payload center of mass based on the payload sensor data received at 1305 and a positional configuration of the weight sensors. The positional configuration of the weight sensors may be provided as an input parameter to method 1300. For example, control unit 110 may determine payload weight and payload center of mass based on the payload sensor data received at 1305 and a positional configuration of the plurality of weight sensors received as an input parameter. In some embodiments, the positional configuration of the weight sensors may be stored in a database of the system performing method 1300 (e.g., database 450 of control unit 110 of system 100).

At 1315, method 1300 may include determining a target position for each of at least one counterweight based at least on the payload weight and payload center of mass determined at 1310. For example, control unit 110 may determine a target position for each of at least one counterweight based at least on the payload weight and payload center of mass determined at 1310. The target position may be determined to control the CG of the RPA by controlling the weight distribution of the RPA.

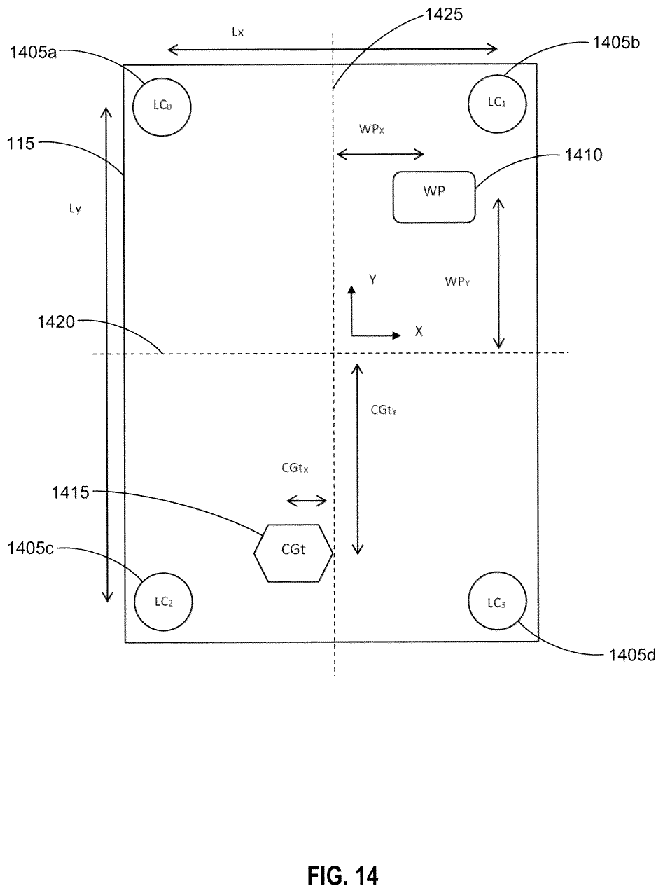

Example calculations that may be performed at 1310 and 1315 of method 1300 are now described with reference to FIG. 14. FIG. 14 is a schematic diagram showing an example configuration of the weight sensors of the payload weighing platform 115. The example calculations may be performed, for example, by target position engine 455 of control unit 110.

The payload weighing platform 115 may include weight sensors 1405a-1405d arranged in a rectangular configuration. The configuration of the guide rails and the counterweights may determine a minimum required number of weight sensors 1405 of the payload weighing platform. For an example system including a single counterweight movable along a single guide rail, the minimum required number of weight sensors can be two. For an example system including two guide rails with one counterweight mounted and movable along each guide rail, the minimum required number can be three weight sensors that are placed at non-colinear points (i.e., the three weight sensors do not fall on the same line).

The distance between the weight sensors in the x direction may be denoted as L_{X}. The distance between the weight sensors in the y direction may be denoted as L_{Y}. The weight data measured by weight sensors 1405a, 1405b, 1405c, and 1405d may be denoted as LC₀, LC₁, LC₂, and LC₃ respectively. The total weight of the payload distributed over the four weight sensors may be represented by a single mass 1410 (denoted by W_{P}) at position (WPₓ, WP_{y}) relative to the origin. The single mass W_{P} and the position coordinates WPₓ and WP_{y} may be determined at 1310 of method 1300.

The target position 1415 for the CG of the entire system (including the RPA, the payload and the system 100 for controlling the weight distribution of the RPA) may be denoted as CGt. The x and y coordinates of the CG target position 1415 may be denoted as CGt_{X} and CGt_{Y} respectively. The counterweight gantry system may include a first counterweight with mass denoted by WBₓ that can be moved in the x direction. The counterweight gantry system may include a second counterweight with mass denoted by WB_{Y} that can be moved in the y direction. The target positions of the counterweight masses may be denoted as Bₓ (x direction) and B_{y} (y direction) respectively. The target positions Bₓ and B_{y} may be determined at 1315 of method 1300.

The calculations may be performed under the following assumptions—/(1) the self-weight of an actuator system used to move the counterweights may be ignored, (2) the counterweights can travel along a gantry aligned with their respective axes and along the symmetric split lines (denoted by the dashed lines 1420 and 1425) of the weighing platform 115, and (3) the gantry for each axis provides sufficient travel for the counterweight to reach the corresponding target position.

Equation 1 can be used to determine the total payload weight based on the sum of the weight data LC₀, LC₁, LC₂, and LC₃ measured by weight sensors 1405a, 1405b, 1405c, and 1405d respectively:

$$W P = \sum \{ L {C}_{0} + L {C}_{1} + L {C}_{2} + L {C}_{3} \} \qquad ( Equation 1 )$$

The total weight of the payload distributed over the four weight sensors can be represented by a single mass at position WPₓ, WP_{y} relative to the origin. A moment balance equation about the y axis (Equation 2) can be used to determine the x coordinate WPₓ of the combined mass:

$$\sum {M}_{y ( at origin )} = W P \times W {P}_{x} \qquad ( Equation 2 )$$

$$\frac{L x}{2} ( L {C}_{1} + L {C}_{3} - L {C}_{0} - L {C}_{2} ) = W P \times W {P}_{x}$$

The x coordinate WPₓ can be determined using Equation 3:

$$W {P}_{x} = \frac{L x}{2 \times W P} ( L {C}_{1} + L {C}_{3} - L {C}_{0} - L {C}_{2} ) \qquad ( Equation 3 )$$

Similarly, a moment balance equation about the x axis (Equation 4) can be used to determine the y coordinate WP_{y} of the combined mass:

$$\sum {M}_{x ( at origin )} = WP \times W {P}_{y} \qquad ( Equation 4 )$$

The y coordinate WP_{y} can be determined using Equation 5:

$$W {P}_{y} = \frac{L y}{2 \times W P} ( L {C}_{0} + L {C}_{1} - L {C}_{2} - L {C}_{3} ) \qquad ( Equation 5 )$$

After the weight and CG coordinates of the payload are calculated, the target positions for the counterweights can be determined. To fully compensate for the payload weight, the total moments created by the payload and counterweights about the CG target position 1415 must sum to zero about each respective axis. Each moment arm may be taken as the maximum length between the CG target position 1415 and the first (x-direction) and second (y-direction) counterweights respectively. The total moment equation created by the payload and counterweights about the y axis (Equation 6) can be used to determine the target position Bₓ:

$$\sum {M}_{y ( at CGt )} = 0 \qquad ( Equation 6 )$$

$$0 = WP \times ( W {P}_{x} - C G {t}_{x} ) + W {B}_{x} \times ( {B}_{x} - C G {t}_{x} ) \qquad ( Equation 7 )$$

Equation 7 can be solved for Bₓ to yield Equation 8 that can be used to determine Bₓ:

$${B}_{x} = - \frac{W P}{W {B}_{x}} \times ( W {P}_{x} - C G {t}_{x} ) + C G {t}_{x} \qquad ( Equation 8 )$$

Similarly, equation 9 can be used to determine B_{y}:

$${B}_{y} = - \frac{W P}{W {B}_{y}} \times ( W {P}_{y} - C G {t}_{y} ) + C G {t}_{y} \qquad ( Equation 9 )$$

The equations 1 to 9 described above can be used to determine target positions for counterweight masses to balance a given payload. For example, the weight data measured by weight sensors 1405a-1405d may be:
LC₀=3 kg
LC₁=4 kg
LC₂=1 kg
LC₃=2 kg

The position of the weight sensors 1405a-1405d can be:
Lx=200 mm
Ly=400 mm

The target position 1415 for the CG may correspond to:
CGtₓ=0 mm
CGt_{y}=−100 mm

The counterweights used for controlling the weight distribution of the RPA can be:
WBₓ=1 kg
WB_{y}=2 kg

The total payload weight can be determined using equation 1:

$$WP = \sum \{ L {C}_{0} + L {C}_{1} + L {C}_{2} + L {C}_{3} \qquad ( Equation 1 )$$

$$WP = 3 + 4 + 1 + 2 = 10 kg$$

The x coordinate WPₓ of the combined mass can be determined using equation 3:

$$W {P}_{x} = \frac{L x}{2 \times W P} ( L {C}_{1} + L {C}_{3} - L {C}_{0} - L {C}_{2} ) \qquad ( Equation 3 )$$

$$W {P}_{x} = \frac{200}{2 \times 10} \times ( 4 + 2 - 3 - 1 )$$

$$W {P}_{x} = 20 mm$$

Similarly, y coordinate WP_{y} of the combined mass can be determined using equation 5:

$$W {P}_{y} = \frac{L y}{2 \times W P} ( L {C}_{0} + L {C}_{1} - L {C}_{2} - L {C}_{3} ) \qquad ( Equation 5 )$$

$$W {P}_{y} = \frac{400}{2 \times 10} \times ( 3 + 4 - 1 - 2 )$$

$$W {P}_{y} = 80 mm$$

After the weight and CG coordinates of the payload are calculated, the target positions for the counterweights can be determined using equations 8 and 9:

$${B}_{x} = - \frac{W P}{W {B}_{x}} \times ( W {P}_{x} - C G {t}_{x} ) + C G {t}_{x} \qquad ( Equation 8 )$$

$${B}_{x} = - \frac{10}{1} \times ( 20 - 0 ) + 0$$

$${B}_{x} = - 200 mm$$

$${B}_{y} = - \frac{W P}{W {B}_{y}} \times ( W {P}_{y} - C G {t}_{y} ) + C G {t}_{y} \qquad ( Equation 9 )$$

$${B}_{y} = - \frac{10}{2} \times ( 80 + 100 ) - 100$$

$${B}_{y} = - 1 \; 000 mm$$

Accordingly, the system may be balanced about the CG target position 1415 by moving the first counterweight to a x direction position of −200 mm and the second counterweight to a y direction position of −1000 mm.

The example calculations described above may be performed for counterweight gantry systems 120a and/or 120b (described with reference to FIGS. 5A-5D) to determine the target position (Bₓ) for the first counterweight 510 and the target position (B_{Y}) for the second counterweight 520.

For a counterweight gantry system that includes a single guide rail (e.g., counterweight gantry systems 120e and/or 120f described with reference to FIGS. 7A and 7B), the example calculations may be performed by setting one of the counterweights (e.g., WB_{y}) to be zero and determining the target position (Bₓ) for the counterweight 710.

For a counterweight gantry system that includes a first guide rail that is fixedly attached to the RPA and a second guide rail that is movably attached to the first guide rail (e.g., counterweight gantry systems 120c and/or 120d described with reference to FIGS. 6A and 6B), the example calculations may be performed by setting both the counterweights WBₓ and WB_{y} to be the same single ballast WB and determining the target positions Bₓ and BY. The single counterweight 610 may be moved to the target position corresponding to Bₓ and B_{Y} by moving the second guide rail 615 along the first guide rail 605 and by moving the counterweight 610 along the second guide rail 615.

For a counterweight gantry system that includes at least three guide rails (e.g., counterweight gantry systems 120g and/or 120h described with reference to FIGS. 8A-8D), the CM of the payload and the target positions for the counterweights must be determined in three dimensions. For example, the payload weighing platform may be angled with reference to the horizontal plane and an additional moment balance equation (in the vertical direction) may be included in the example calculations to determine the target positions in all three dimensions.

For a counterweight gantry system that includes circular and radial guide rails (e.g., counterweight gantry systems 120i and/or 120j described with reference to FIGS. 9A and 9B), the example calculations may be updated with conversion to polar coordinates. The cartesian coordinates (x, y) may be converted to polar coordinates (r, θ) using equations 10 and 11, where θ can be the angle (in radians) measured from the positive x axis (dashed horizontal line 1420) and r can be the radial distance from the origin:

$$r = \sqrt{{x}^{2} + {y}^{2}} \qquad ( Equation 10 )$$

$$θ = a tan 2 ( y , x ) \qquad ( Equation 11 )$$

where atan2 is the 2-argument arctangent function for −π<θ≤π.

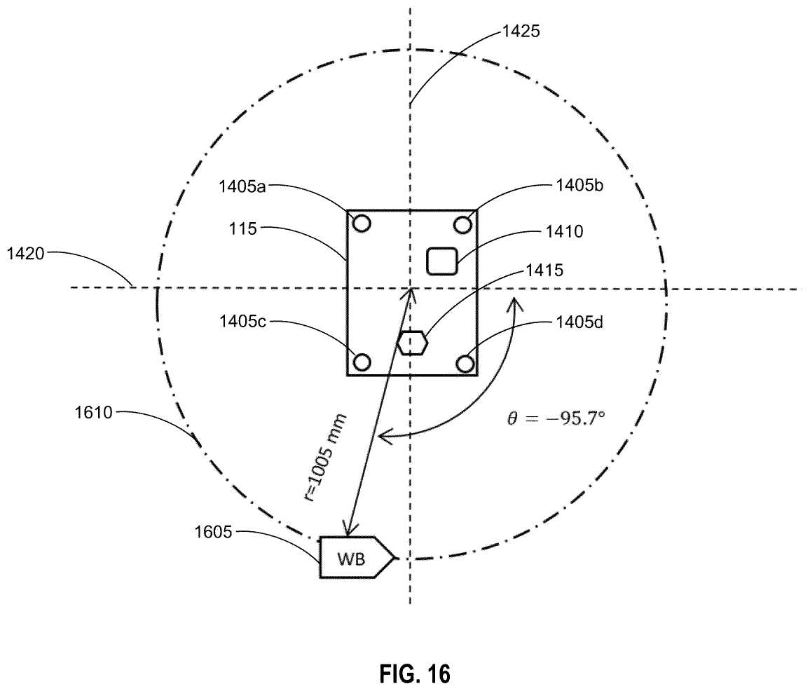

Referring now to FIG. 16, shown therein is a schematic diagram showing a counterweight 1605 in addition to the payload weighing platform 115 and weight sensors 1405a-1405d previously shown in FIG. 14. The counterweight 1605 may have a mass WB=2 kg and may be moved to positions defined by circle 1610. For the example shown in FIG. 16, the center of circle 1610 is coincident with the origin of the payload weighing platform 115.

Bₓ and By can be determined using equations 8 and 9 (using WB for both WBₓ and WB_{y}) as follows:

$${B}_{x} = - \frac{W P}{W B} \times ( W {P}_{x} - C G {t}_{x} ) + C G {t}_{x} \qquad ( Equation 8 )$$

$${B}_{x} = - 100 mm$$

$${B}_{y} = - \frac{W P}{W B} \times ( W {P}_{y} - C G {t}_{y} ) + C G {t}_{y} \qquad ( Equation 9 )$$

$${B}_{y} = - 1 \; 000 mm$$

Therefore, the counterweight 1605 may be actuated to the position (x, y)= (−100 mm, −1000 mm) to control the CG to the target position 1415. Equations 10 and 11 may be used to convert the cartesian coordinates to polar coordinates. For the example values of Bₓ=−100 mm and B_{y}=−1000 mm, the target position for counterweight 1605 may be calculated using equations 10 and 11 (and is shown in FIG. 16) to be (r=1005 mm and θ=−1.67rad).

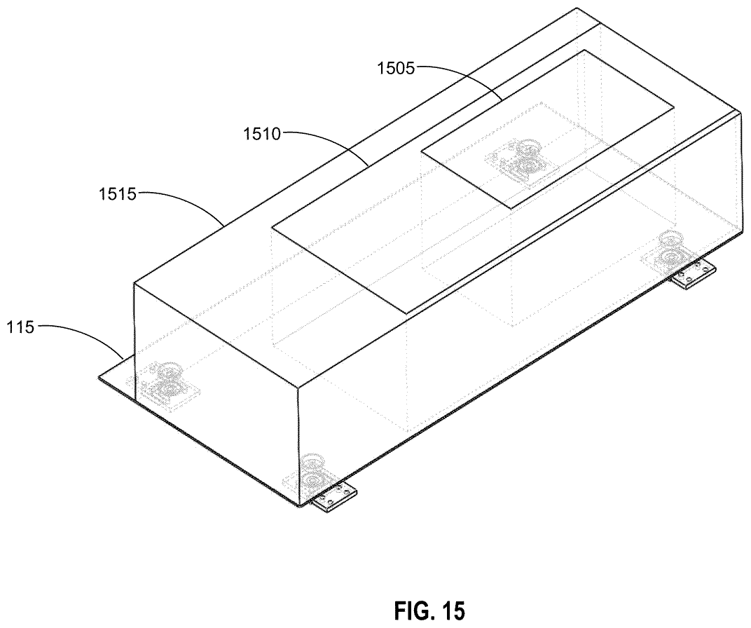

The moment balance equations described herein above indicate that the capacity for controlling RPA weight distribution of a given system can depend on the total mass of the payload and a CM position of the payload. The CM position of the payload can depend on the mass, shape, size and loaded position of the payload. Reference is now made to FIG. 15 showing a schematic diagram of CM position envelopes for different payload masses that may be balanced by an example system to control CG of an RPA. FIG. 15 shows CM position ranges 1505, 1510, and 1515 on payload weighing platform 115 for example payload masses of 120 kg, 100 kg and 50 kg respectively. The position range 1505, with the lowest mass can be smaller compared with position range 1510 and the position range 1510, with the moderate mass can be smaller compared with position range 1515, with the highest mass, indicating that positional flexibility may be reduced as the payload mass increases.

Referring back to FIG. 13, at 1320, method 1300 may include providing a counterweight position signal including the target position determined at 1315 to a counterweight gantry system. The counterweight gantry system may be attached to the RPA and include at least one counterweight. For example, control unit 110 may provide the counterweight position signal to counterweight gantry system 120. The counterweight gantry system may be configured to move each counterweight to a corresponding target position in response to receiving the counterweight position signal.

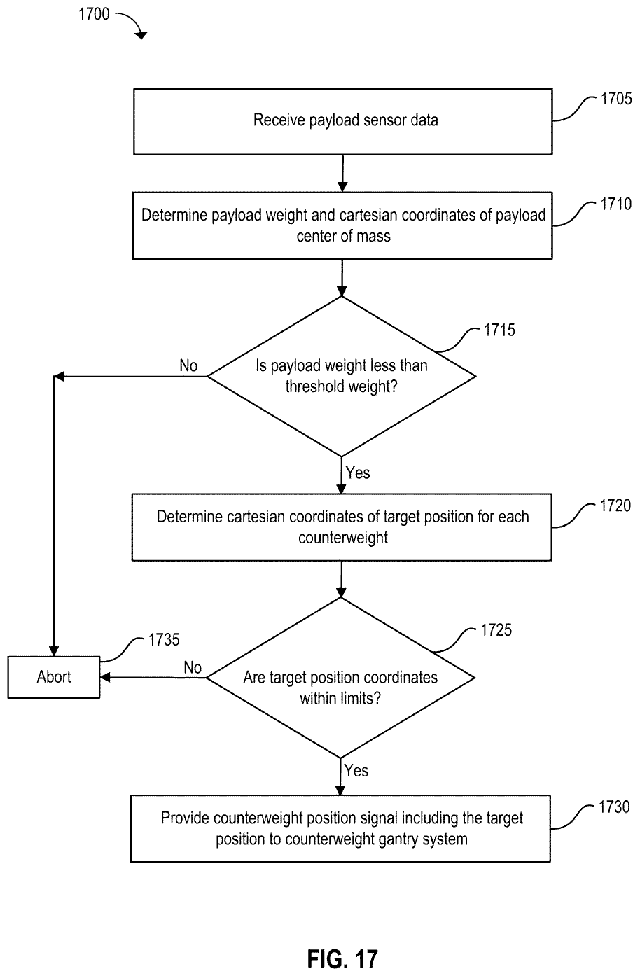

Referring now to FIG. 17, shown therein is a flowchart of an example method 1700 for controlling weight distribution of an RPA, in accordance with another embodiment. Method 1700 can be implemented using, for example, system 100 shown in FIG. 1.

Method 1700 can be performed at various times. For example, method 1700 may be performed after loading a payload on an RPA for transportation from a location A to a location B. After the RPA reaches location B and the payload is unloaded from the RPA, method 1700 may be performed for the next flight operation of the RPA. For example, the next flight operation may be without any payload and method 1700 may be performed after the original payload is unloaded. If a new payload is loaded at location B, method 1700 may be performed after the original payload is unloaded and the new payload is loaded.

Method 1700 may be performed in response to input received from an operator of system 100. For example, an operator may provide an input to control unit 110 to begin method 1700. In some embodiments, method 1700 may not be performed when the RPA is in flight. For example, the method 1700 may only be performed if an aircraft control system of the RPA provides an input to system 100 indicating that the RPA is not in flight.

At 1705, method 1700 may include receiving payload sensor data from a payload weighing platform positioned within the RPA. For example, the payload sensor data may be received by control unit 110 from payload weighing platform 115 positioned within RPA 105. As described herein above with reference to FIGS. 3A-3F, the payload weighing platform 115 may include multiple weight sensors 305 configured to generate payload sensor data indicating measured weight values associated with a payload received at the payload weighing platform 115.

At 1710, method 1700 may include determining payload weight and the cartesian coordinates of the payload CM based on the payload sensor data received at 1705 and a positional configuration of the weight sensors. The positional configuration of the weight sensors may be provided as an input parameter to method 1700. For example, control unit 110 may determine payload weight and payload center of mass based on the payload sensor data received at 1705 and a positional configuration of the plurality of weight sensors received as an input parameter. In some embodiments, the positional configuration of the weight sensors may be stored in a database of the system performing method 1700 (e.g., database 450 of control unit 110 of system 100).

At 1715, method 1700 may include determining whether the payload weight determined at 1710 is less than a threshold weight. For example, control unit 110 may determine whether the payload weight determined at 1710 is less than a threshold weight. The threshold weight may be based on a total payload capacity of the RPA.

If the payload weight determined at 1710 is less than the threshold weight, method 1700 may proceed to 1720. If the payload weight determined at 1710 is not less than the threshold weight, the method 1700 may abort at 1735. Human operator intervention may be required after method 1700 aborts. In some embodiments, an automatic response may be triggered when method 1700 aborts.

At 1720, method 1700 may include determining the cartesian coordinates of the target position for each counterweight of the counterweight gantry system. For example, control unit 110 may determine the cartesian coordinates of the target position for each counterweight of the counterweight gantry system. The target position may be determined to control a CG of the RPA by controlling the weight distribution of the RPA. The cartesian coordinates of the target position may be calculated using the equations 1 to 9 described herein above with reference to FIG. 14.

At 1725, method 1700 may include determining whether the target position coordinates determined at 1720 are within limits. For example, control unit 110 may determine whether the target position coordinates determined at 1720 are within limits. The limits may be provided to control unit 110 as input parameters. The limits may be based on the mechanical limitations of the counterweight gantry system (e.g., the maximum distance that the counterweights can be moved and/or the mass of each counterweight).

If the target position coordinates determined at 1720 are not within limits, method 1700 may abort at 1735. If the target position coordinates determined at 1720 are within limits, method 1700 may proceed to 1730.

At 1730, method 1700 may include providing a counterweight position signal including the target position cartesian coordinates determined at 1720 to a counterweight gantry system. The counterweight gantry system may be attached to an exterior of the RPA and include at least one counterweight. For example, control unit 110 may provide the counterweight position signal to counterweight gantry system 120. The counterweight gantry system may be configured to move each counterweight to a corresponding target position in response to receiving the counterweight position signal.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Clauses

Clause 1: A system for controlling weight distribution of a remotely piloted aircraft, the system comprising: a payload weighing platform configured to be positioned within the aircraft and receive the payload, the payload weighing platform comprising a plurality of weight sensors configured to generate payload sensor data indicating measured weight values; a control unit configured to: receive the payload sensor data from the payload weighing platform; determine a payload weight and a payload center of mass based on the payload sensor data and a positional configuration of the plurality of weight sensors; determine a target position for each of at least one counterweight based at least on the payload weight and the payload center of mass, the target position determined to control a center of gravity of the aircraft by controlling the weight distribution of the aircraft; and provide a counterweight position signal to a counterweight gantry system, the counterweight position signal including the target position; and the counterweight gantry system attached to the aircraft and comprising the at least one counterweight, the counterweight gantry system configured to move each of the at least one counterweight to corresponding target position in response to receiving the counterweight position signal.

Clause 2: The system of any of the above clauses, wherein each of the at least one counterweight is mounted on a corresponding guide rail, and the counterweight gantry system further comprises an actuator system configured to move each of the at least one counterweight to the corresponding target position by: moving the counterweight along the corresponding guide rail; or moving the corresponding guide rail along with the mounted counterweight.

Clause 3: The system of any of the above clauses, wherein the payload weighing platform comprises four weight sensors arranged in a rectangular configuration around four corners of the payload weighing platform.

Clause 4: The system of any of the above clauses, wherein the payload weighing platform comprises three weight sensors arranged in a triangular configuration around a center of the payload weighing platform.

Clause 5: The system of any of the above clauses, wherein the counterweight gantry system comprises at least two counterweights and further comprises: a first guide rail fixedly attached to the aircraft and generally parallel to a longitudinal axis of the aircraft, wherein a first counterweight of the at least two counterweights is movably mounted on the first guide rail; and a second guide rail fixedly attached to the aircraft and generally parallel to a lateral axis of the aircraft, wherein a second counterweight of the at least two counterweights is movably mounted on the second guide rail, wherein the actuator system is configured to: move the first counterweight to a first target position by moving the first counterweight along the first guide rail; and move the second counterweight to a second target position by moving the second counterweight along the second guide rail.

Clause 6: The system of any of the above clauses, wherein the counterweight gantry system further comprises at least one of the first guide rail being offset from the longitudinal axis by a first offset distance and the second guide rail being offset from the lateral axis by a second offset distance.

Clause 7: The system of any of the above clauses, wherein the counterweight gantry system further comprises: a first guide rail fixedly attached to the aircraft and generally parallel to a longitudinal axis of the aircraft; and a second guide rail generally parallel to a lateral axis of the aircraft and movably attached to the first guide rail, wherein the second guide rail is configured to move along the first guide rail, wherein the at least one counterweight is movably mounted on the second guide rail and the actuator system is configured to move the at least one counterweight to the corresponding target position by moving the at least one counterweight along the second guide rail and by moving the second guide rail along the first guide rail.

Clause 8: The system of any of the above clauses, wherein the counterweight gantry system further comprises: a circular guide rail fixedly attached to the aircraft, wherein the circular guide rail circumscribes a majority portion of the aircraft; and a radial guide rail movably attached to the circular guide rail to enable the radial guide rail to move circumferentially around the circular guide rail, wherein the at least one counterweight is movably mounted on the radial guide rail and the actuator system is configured to move the at least one counterweight to the corresponding target position by moving the at least one counterweight along the radial guide rail and by moving the radial guide rail circumferentially around the circular guide rail.

Clause 9: The system of any of the above clauses, wherein the counterweight gantry system comprises the at least one counterweight movably mounted on a longitudinal guide rail fixedly attached to the aircraft and generally parallel to the longitudinal axis of the aircraft; and wherein the actuator system is configured to move the at least one counterweight to the corresponding target position by moving the at least one counterweight along the longitudinal guide rail.

Clause 10: The system of any of the above clauses, wherein the counterweight gantry system further comprises: a vertical guide rail fixedly attached to the aircraft and generally parallel to a normal axis of the aircraft; and a vertical counterweight movably mounted on the vertical guide rail, wherein the actuator system is configured to move the vertical counterweight to the corresponding target position by moving the vertical counterweight along the vertical guide rail.

Clause 11: The system of any of the above clauses, wherein the counterweight gantry system is attached to an exterior of the aircraft.

Clause 12: A computer-implemented method for controlling weight distribution of a remotely piloted aircraft, the method comprising: receiving, at a processor, payload sensor data from a payload weighing platform positioned within the aircraft, the payload weighing platform comprising a plurality of weight sensors configured to generate the payload sensor data indicating measured weight values associated with a payload received at the payload weighing platform; determining, at the processor, a payload weight and a payload center of mass of the payload based on the payload sensor data and a positional configuration of the plurality of weight sensors; determining, at the processor, a target position for each of at least one counterweight based at least on the payload weight and the payload center of mass, the target position determined to control a center of gravity of the aircraft by controlling the weight distribution of the aircraft; and providing, by the processor, a counterweight position signal including the target position to a counterweight gantry system attached to the aircraft and comprising the at least one counterweight, the counterweight gantry system configured to move each of the at least one counterweight to corresponding target position in response to receiving the counterweight position signal.

Clause 13: The method of any of the above clauses, wherein each of the at least one counterweight is mounted on a corresponding guide rail, and the counterweight gantry system further comprises an actuator system configured to move each of the at least one counterweight to the corresponding target position by: moving the counterweight along the corresponding guide rail; or moving the corresponding guide rail along with the mounted counterweight.

Clause 14: The method of any of the above clauses, wherein the payload weighing platform comprises four weight sensors arranged in a rectangular configuration around four corners of the payload weighing platform.

Clause 15: The method of any of the above clauses, wherein the payload weighing platform comprises three weight sensors arranged in a triangular configuration around a center of the payload weighing platform.

Clause 16: The method of any of the above clauses, wherein the counterweight gantry system comprises at least two counterweights and further comprises: a first guide rail fixedly attached to the aircraft and generally parallel to a longitudinal axis of the aircraft, wherein a first counterweight of the at least two counterweights is movably mounted on the first guide rail; and a second guide rail fixedly attached to the aircraft and generally parallel to a lateral axis of the aircraft, wherein a second counterweight of the at least two counterweights is movably mounted on the second guide rail, wherein the actuator system is configured to: move the first counterweight to a first target position by moving the first counterweight along the first guide rail; and move the second counterweight to a second target position by moving the second counterweight along the second guide rail.

Clause 17: The method of any of the above clauses, wherein the counterweight gantry system further comprises at least one of the first guide rail being offset from the longitudinal axis by a first offset distance and the second guide rail being offset from the lateral axis by a second offset distance.

Clause 18: The method of any of the above clauses, wherein the counterweight gantry system further comprises: a first guide rail fixedly attached to the aircraft and generally parallel to a longitudinal axis of the aircraft; and a second guide rail generally parallel to a lateral axis of the aircraft and movably attached to the first guide rail, wherein the second guide rail is configured to move along the first guide rail, wherein the at least one counterweight is movably mounted on the second guide rail and the actuator system is configured to move the at least one counterweight to the corresponding target position by moving the at least one counterweight along the second guide rail and by moving the second guide rail along the first guide rail.

Clause 19: The method of any of the above clauses, wherein the counterweight gantry system further comprises: a circular guide rail fixedly attached to the aircraft, wherein the circular guide rail circumscribes a majority portion of the aircraft; and a radial guide rail movably attached to the circular guide rail to enable the radial guide rail to move circumferentially around the circular guide rail, wherein the at least one counterweight is movably mounted on the radial guide rail and the actuator system is configured to move the at least one counterweight to the corresponding target position by moving the at least one counterweight along the radial guide rail and by moving the radial guide rail circumferentially around the circular guide rail.

Clause 20: The method of any of the above clauses, wherein the counterweight gantry system comprises the at least one counterweight movably mounted on a longitudinal guide rail fixedly attached to the aircraft and generally parallel to the longitudinal axis of the aircraft; and wherein the actuator system is configured to move the at least one counterweight to the corresponding target position by moving the at least one counterweight along the longitudinal guide rail.

Clause 21: The method of any of the above clauses, wherein the counterweight gantry system further comprises: a vertical guide rail fixedly attached to the aircraft and generally parallel to a normal axis of the aircraft; and a vertical counterweight movably mounted on the vertical guide rail, wherein the actuator system is configured to move the vertical counterweight to the corresponding target position by moving the vertical counterweight along the vertical guide rail.

Clause 22: The method of any of the above clauses, wherein the counterweight gantry system is attached to an exterior of the aircraft.

We claim:

1. A system for controlling weight distribution of a remotely piloted aircraft, the system comprising:
a payload weighing platform configured to be positioned within the aircraft and receive the payload, the payload weighing platform comprising a plurality of weight sensors configured to generate payload sensor data indicating measured weight values;
a control unit configured to:
receive the payload sensor data from the payload weighing platform;
determine a payload weight and a payload center of mass based on the payload sensor data and a positional configuration of the plurality of weight sensors;
determine a target position for each of at least one counterweight based at least on the payload weight and the payload center of mass, the target position determined to control a center of gravity of the aircraft by controlling the weight distribution of the aircraft; and
provide a counterweight position signal to a counterweight gantry system, the counterweight position signal including the target position; and
the counterweight gantry system attached to the aircraft and comprising the at least one counterweight, the counterweight gantry system configured to move each of the at least one counterweight to corresponding target position in response to receiving the counterweight position signal.

2. The system of claim 1, wherein each of the at least one counterweight is mounted on a corresponding guide rail, and the counterweight gantry system further comprises an actuator system configured to move each of the at least one counterweight to the corresponding target position by:
moving the counterweight along the corresponding guide rail; or
moving the corresponding guide rail along with the mounted counterweight.

3. The system of claim 1, wherein the payload weighing platform comprises four weight sensors arranged in a rectangular configuration around four corners of the payload weighing platform.

4. The system of claim 1, wherein the payload weighing platform comprises three weight sensors arranged in a triangular configuration around a center of the payload weighing platform.

5. The system of claim 2, wherein the counterweight gantry system comprises at least two counterweights and further comprises:
a first guide rail fixedly attached to the aircraft and generally parallel to a longitudinal axis of the aircraft, wherein a first counterweight of the at least two counterweights is movably mounted on the first guide rail; and
a second guide rail fixedly attached to the aircraft and generally parallel to a lateral axis of the aircraft, wherein a second counterweight of the at least two counterweights is movably mounted on the second guide rail,
wherein the actuator system is configured to:
move the first counterweight to a first target position by moving the first counterweight along the first guide rail; and
move the second counterweight to a second target position by moving the second counterweight along the second guide rail.

6. The system of claim 5, wherein the counterweight gantry system further comprises at least one of the first guide rail being offset from the longitudinal axis by a first offset distance and the second guide rail being offset from the lateral axis by a second offset distance.

7. The system of claim 2, wherein the counterweight gantry system further comprises:
a first guide rail fixedly attached to the aircraft and generally parallel to a longitudinal axis of the aircraft; and
a second guide rail generally parallel to a lateral axis of the aircraft and movably attached to the first guide rail, wherein the second guide rail is configured to move along the first guide rail,
wherein the at least one counterweight is movably mounted on the second guide rail and the actuator system is configured to move the at least one counterweight to the corresponding target position by moving the at least one counterweight along the second guide rail and by moving the second guide rail along the first guide rail.

8. The system of claim 2, wherein the counterweight gantry system further comprises:
a circular guide rail fixedly attached to the aircraft, wherein the circular guide rail circumscribes a majority portion of the aircraft; and
a radial guide rail movably attached to the circular guide rail to enable the radial guide rail to move circumferentially around the circular guide rail,
wherein the at least one counterweight is movably mounted on the radial guide rail and the actuator system is configured to move the at least one counterweight to the corresponding target position by moving the at least one counterweight along the radial guide rail and by moving the radial guide rail circumferentially around the circular guide rail.

9. The system of claim 2, wherein the counterweight gantry system comprises the at least one counterweight movably mounted on a longitudinal guide rail fixedly attached to the aircraft and generally parallel to the longitudinal axis of the aircraft; and wherein the actuator system is configured to move the at least one counterweight to the corresponding target position by moving the at least one counterweight along the longitudinal guide rail.

10. The system of claim 5, wherein the counterweight gantry system further comprises:
a vertical guide rail fixedly attached to the aircraft and generally parallel to a normal axis of the aircraft; and
a vertical counterweight movably mounted on the vertical guide rail, wherein the actuator system is configured to move the vertical counterweight to the corresponding target position by moving the vertical counterweight along the vertical guide rail.

11. The system of claim 1, wherein the counterweight gantry system is attached to an exterior of the aircraft.

12. A computer-implemented method for controlling weight distribution of a remotely piloted aircraft, the method comprising:
receiving, at a processor, payload sensor data from a payload weighing platform positioned within the aircraft, the payload weighing platform comprising a plurality of weight sensors configured to generate the payload sensor data indicating measured weight values associated with a payload received at the payload weighing platform;
determining, at the processor, a payload weight and a payload center of mass of the payload based on the payload sensor data and a positional configuration of the plurality of weight sensors;
determining, at the processor, a target position for each of at least one counterweight based at least on the payload weight and the payload center of mass, the target position determined to control a center of gravity of the aircraft by controlling the weight distribution of the aircraft; and
providing, by the processor, a counterweight position signal including the target position to a counterweight gantry system attached to the aircraft and comprising the at least one counterweight, the counterweight gantry system configured to move each of the at least one counterweight to corresponding target position in response to receiving the counterweight position signal.

13. The method of claim 12, wherein each of the at least one counterweight is mounted on a corresponding guide rail, and the counterweight gantry system further comprises an actuator system configured to move each of the at least one counterweight to the corresponding target position by:
moving the counterweight along the corresponding guide rail; or
moving the corresponding guide rail along with the mounted counterweight.

14. The method of claim 13, wherein the counterweight gantry system comprises at least two counterweights and further comprises:
a first guide rail fixedly attached to the aircraft and generally parallel to a longitudinal axis of the aircraft, wherein a first counterweight of the at least two counterweights is movably mounted on the first guide rail; and
a second guide rail fixedly attached to the aircraft and generally parallel to a lateral axis of the aircraft, wherein a second counterweight of the at least two counterweights is movably mounted on the second guide rail,
wherein the actuator system is configured to:
move the first counterweight to a first target position by moving the first counterweight along the first guide rail; and
move the second counterweight to a second target position by moving the second counterweight along the second guide rail.

15. The method of claim 14, wherein the counterweight gantry system further comprises at least one of the first guide rail being offset from the longitudinal axis by a first offset distance and the second guide rail being offset from the lateral axis by a second offset distance.

16. The method of claim 13, wherein the counterweight gantry system further comprises:
a first guide rail fixedly attached to the aircraft and generally parallel to a longitudinal axis of the aircraft; and
a second guide rail generally parallel to a lateral axis of the aircraft and movably attached to the first guide rail, wherein the second guide rail is configured to move along the first guide rail,
wherein the at least one counterweight is movably mounted on the second guide rail and the actuator system is configured to move the at least one counterweight to the corresponding target position by moving the at least one counterweight along the second guide rail and by moving the second guide rail along the first guide rail.

17. The method of claim 13, wherein the counterweight gantry system further comprises:
a circular guide rail fixedly attached to the aircraft, wherein the circular guide rail circumscribes a majority portion of the aircraft; and
a radial guide rail movably attached to the circular guide rail to enable the radial guide rail to move circumferentially around the circular guide rail,
wherein the at least one counterweight is movably mounted on the radial guide rail and the actuator system is configured to move the at least one counterweight to the corresponding target position by moving the at least one counterweight along the radial guide rail and by moving the radial guide rail circumferentially around the circular guide rail.

18. The method of claim 13, wherein the counterweight gantry system comprises the at least one counterweight movably mounted on a longitudinal guide rail fixedly attached to the aircraft and generally parallel to the longitudinal axis of the aircraft; and wherein the actuator system is configured to move the at least one counterweight to the corresponding target position by moving the at least one counterweight along the longitudinal guide rail.

19. The method of claim 14, wherein the counterweight gantry system further comprises:
a vertical guide rail fixedly attached to the aircraft and generally parallel to a normal axis of the aircraft; and
a vertical counterweight movably mounted on the vertical guide rail, wherein the actuator system is configured to move the vertical counterweight to the corresponding target position by moving the vertical counterweight along the vertical guide rail.

20. The method of claim 12, wherein the counterweight gantry system is attached to an exterior of the aircraft.
